(19) United States
(12) Patent Application Publication
(10) Pub. No.: US 2009/0055267 A1
(43) Pub. Date: Feb. 26, 2009

(54) INTERNET ADVERTISING BROKERAGE APPARATUS, SYSTEMS, AND METHODS

(76) Inventor: Robert Roker, Vancouver (CA)

Correspondence Address: SCHWEGMAN, LUNDBERG & WOESSNER, P.A., P.O. BOX 2938, MINNEAPOLIS, MN, 55402, US

(21) Appl. No.: 12/133,544

(22) Filed: Jun. 5, 2008

Related U.S. Application Data
(60) Provisional application No. 60/957,631, filed on Aug. 23, 2007.
(60) Provisional application No. 60/969,465, filed on Aug. 31, 2007.
(60) Provisional application No. 60/976,335, filed on Sep. 28, 2007.

(51) Int. Cl. G06Q 30/00; G06F 17/30; G06F 15/16

(52) U.S. Cl. 705/14; 707/3; 707/10; 707/104.1; 709/203; 707/E17.044; 707/E17.014

(57) ABSTRACT

Apparatus, systems, and methods herein acquire and develop ad targeting relevancy information, route the relevancy information through a network, and use the relevancy information to prioritize ad flows and to select targeted, high-value ads to deliver to subscribers. Some example embodiments may intercept a subscriber internet access stream and/or interact with one or more subscriber information sources to acquire and develop the relevancy information. The relevancy information may then be introduced into the ad delivery ecosystem. Other example embodiments are described and claimed.

### PRIORITY

This disclosure claims the benefit of the filing date of Provisional Patent Applications Ser. No. 60/957,631 (Attorney Docket No. 2637.002PRV) filed on Aug. 23, 2007 and titled “Internet Advertising Brokerage Apparatus, Systems, and Methods,” Ser. No. 60/969,465 (Attorney Docket No. 2637.002PV2) filed on Aug. 31, 2007 and titled “Internet Advertising Brokerage Apparatus, Systems, and Methods,” and Ser. No. 60/976,335 (Attorney Docket No. 2637.002PV3) filed on Sep. 28, 2007 and titled “Internet Advertising Brokerage Apparatus, Systems, and Methods.” The latter applications are commonly assigned to the assignee of the instant application, Adzilla, Inc. and are incorporated herein by reference in their entirety.

### TECHNICAL FIELD

The present disclosure relates generally to internet advertising, including apparatus, systems, and methods to deliver targeted advertisements according to internet subscriber profiles.

### BACKGROUND

The rapid expansion of the Internet in recent years has led to the rise of internet advertising. Advertisers, content publishers, search engine sites, and advertisement (“ad”) brokers have developed an infrastructure for the delivery of ads referred to as an “ad network.” A content publisher agrees to permit the delivery of ads to specified portions of its content pages as the content pages are viewed by a content consumer. Content consumers include “users” or “subscribers.” An advertiser typically compensates a content publisher for the use of a portion of a content page to display the advertiser's ad. Ad brokers may insert themselves in the middle of the transaction by facilitating the delivery of high-value ad content and receiving a portion of the ad revenues.

Considering an example hypertext transport protocol (HTTP) exchange, a user may enter “Bahamas” into a search engine search field to obtain information about travel to the Bahamas. The search engine may return a list of uniform resource locators (URLs) related to the Bahamas. The user may click on one of the URLs related to travel in the Bahamas. The user's browser sends an HTTP request for the desired URL to the selected website (the “content provider”). The website may then return one or more HTTP response messages containing the page content.

The website may embed an ad “slot” in one or more of the responses. The ad slot effectively reserves a blank space on the page as displayed to the user for subsequent insertion of an ad. Operating according to HTTP protocols, the browser may send a request message back to the content provider to request the ad. The content provider may then send a response message back to the user with the ad appended or may forward the user ad request to an ad broker or to the advertising entity itself for fulfillment of the ad.

### BRIEF DESCRIPTION OF THE DRAWINGS

FIG. 1 is a block diagram of an internet advertising network according to various example embodiments.

FIG. 1A is a sequence diagram illustrating one of the example ad delivery methods previously described.

FIG. 2 is a block diagram of an internet advertising network serving an aggregation of internet service providers of various types according to various example embodiments.

FIG. 3 is a block diagram of an internet advertising network including a tiered internet provider network according to various example embodiments.

FIG. 4 is a block diagram of an internet advertising network including an internet hosted services environment according to various example embodiments.

FIG. 5 is a block diagram of an internet advertising network including an internet third-party services environment according to various example embodiments.

FIG. 6 is a block diagram of an internet advertising network enabled using an internet access computing device according to various example embodiments.

FIGS. 7A and 7B are block diagrams illustrating closely-coupled and embedded adcasters according to various example embodiments.

FIG. 8 is a block diagram of an internet advertising network including a hierarchy of internet advertising brokerage apparatus according to various example embodiments.

FIG. 9 is a block diagram of an internet advertising network illustrating functional interaction between an internet advertising brokerage apparatus and an adcaster according to various example embodiments.

FIG. 10 is a block diagram of an adcaster according to various example embodiments.

FIG. 11 is a field layout diagram of a record associated with a subscriber RT database according to various example embodiments.

FIG. 11A is a block diagram showing a mechanism for pinpointing individual users associated with a shared computer according to various example embodiments.

FIG. 11B is a block diagram showing a mechanism for pinpointing an individual user and an IACD associated with the individual user in a shared-IP environment according to various example embodiments.

FIG. 12 is an example field layout diagram of a record associated with a publisher database according to various example embodiments.

FIG. 13 is a block diagram of an internet advertising brokerage apparatus according to various example embodiments.

FIG. 14 is a field layout diagram of a record associated with an ad inventory database according to various example embodiments.

FIG. 15 is a field layout diagram of a record associated with an ad performance statistics database according to various example embodiments.

FIGS. 16A-16D are field layout diagrams of records associated with a configuration server database according to various example embodiments.

FIG. 17 is a functional block diagram illustrating relevancy information flow according to various example embodiments.

FIG. 18 is an example ontology database search results table and associated ontology hierarchies used in relevancy tag synthesis according to various example embodiments.

FIG. 19 is a flow diagram illustrating a method of relevancy tag enhancement at an adcaster according to an example embodiment.

FIG. 20 is a flow diagram illustrating a method of relevancy tag enhancement at an IABA according to an example embodiment.

FIG. 21 is a functional block diagram illustrating ad opportunity processing information flow according to various example embodiments.

FIG. 22 is a flow diagram illustrating a method associated with an ad placement opportunity according to an example embodiment.

FIG. 22A is an ad database record diagram showing ad campaign-based ad selection according to various example embodiments.

FIG. 23 is a functional block diagram illustrating adcaster configuration and monitoring information flow according to various example embodiments.

FIG. 24 is a flow diagram illustrating a method associated with adcaster configuration operations according to an example embodiment.

FIG. 25 is a flow diagram illustrating a method associated with adcaster monitoring operations according to an example embodiment.

FIG. 26 is a block diagram illustrating an ad-hop bypass method according to various example embodiments.

FIG. 27 is a sequence diagram illustrating an example method of trapping unfulfilled ad requests from an ad network or ad publisher.

FIG. 28 is a block diagram illustrating several example methods and apparatus for directing RTs within a network.

FIG. 29 is a block diagram of a computer for executing a plurality of instructions to perform one or more of the methodologies described herein according to an example embodiment.

FIG. 30 is a block diagram of personal information containment architecture according to various example embodiments.

### DETAILED DESCRIPTION

Apparatus, systems, and methods described herein acquire user subscriber information from available sources and use the information to deliver advertisements (“ads”) targeted to a particular subscriber.

### Overview

Example embodiments described herein implement novel methods to acquire and develop ad targeting relevancy information, route the relevancy information through a network, and use the relevancy information to prioritize ad flows and to select targeted, high-value ads to deliver to subscribers. Some example embodiments may intercept a subscriber internet access stream and/or interact with one or more subscriber information sources to acquire and develop the relevancy information. The relevancy information may then be introduced into the current advertising ecosystem.

Relevancy information may comprise various types of content capable of transmission as a hypertext transport protocol (HTTP) data stream. Relevancy information may, for example, include transactional data such as the existence of bids to acquire publisher space and/or the value of such bids. Relevancy information may also comprise the content of an ad, references to sources of content by third parties, indicators related to the relevance of alternate ads, and/or information acquired by a subscriber or derived by the subscriber.

Relevancy information may include information captured from browsing sessions or derived therefrom. Such information may include keywords being searched on websites, subscriber behavioral patterns including web surfing trends, information held by an internet service provider (ISP) in the ISP's subscriber database, information derived from ISP network equipment or other network communication equipment.

Relevancy information may also comprise usage data compiled by internet ratings organizations and other third-party data that may be used to link to or extend the usage data with additional relevancy information. Operations associated with some example embodiments herein may occur at a level of abstraction such as to render the operations independent of the method of acquiring the relevancy information.

Some embodiments may also use the relevancy information to deliver advertising, user communications, or other network-based, value-added services. For example, relevancy information may be used to enhance the methods of alternate ad propositions, content replacement, white space creation for delivery of additional content, and internet data stream interruption for interstitial content delivery, among others. An ISP may use example embodiments herein to differentiate the ISP's services from the competition, to provide a more relevant browsing experience, and/or to further monetize the ISP's subscriber base.

Example embodiments herein may operate as a transport mechanism to transport the relevancy information into a network HTTP stream. Prior to transmission, the relevancy information may be assembled into a format recognizable by a receiving party in an ad network. Ad network participants may evaluate the relevancy information to decide whether to accept or reject ad placement and sourcing opportunities. The relevancy information may be used to prioritize ad flows and to select highly-targeted, high-value ads.

### Network Architecture

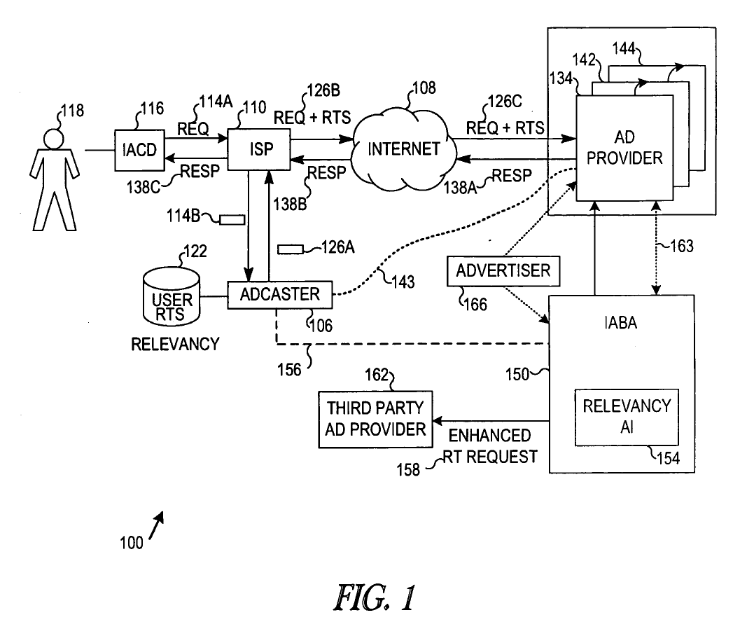

FIG. 1 is a block diagram of an internet advertising network (IAN) 100 according to various example embodiments. The IAN 100 may comprise an internet access stream intercept device referred to herein by way of example as an “adcaster.” An adcaster 106 may be coupled to an internet service provider (ISP) network 110. “ISP” as used herein includes any entity providing connectivity and bandwidth to the Internet 108. As such, an ISP may comprise a traditional retail internet service provider, a corporate network, a wireless provider, an upstream provider, and an MSO, among others. The term “wireless ISP” includes any service provider whose subscribers communicate over radio-frequency channels, including satellite communications.

The ISP network 110 diverts a subscriber ad request 114A and 114B received from an internet access computing device (IACD) 116 associated with a subscriber 118 and communicatively coupled to the ISP network 110. The IACD 116 may comprise a desktop computer, a laptop computer, a hand-held computer, a web-enable cellular telephone, a voice-over-internet (VoIP) protocol telephone, or an internet protocol television (IPTV) device, among other such devices.

An ad provider 134 may also be communicatively coupled to the ISP network 110. The ad request 114A, 114B, content access requests preceding the ad request 114A, 114B, and/or various responses received from the ad provider 134 may be diverted to the adcaster 106. The ISP network 110 and the adcaster 106 may operate cooperatively according to a web cache communication protocol (WCCP), a redirection by packet inspection and alteration mechanism, a traffic shaping mechanism, a policy-based routing mechanism, or other suitable vectoring mechanism or protocol. The redirection mechanism may be standards-based or proprietary, and may comprise a specialized device or switch. The mechanism redirects the ad request 114A, 114B and/or the various responses received from the ad provider 134 to the adcaster 106. The terms “redirection” and “vectoring” may be used interchangeably herein. In an example embodiment the adcaster 106 may be integrated within the ISP network 110.

The adcaster 106 may develop relevancy information from the subscriber ad request 114A, 114B, from the various responses received from the ad provider 134, and/or from subscriber information 122 made available to the adcaster 106. The subscriber information 122 may be provided in a subscriber database maintained by the ISP network 110 or other source. In an example embodiment the adcaster 106 may include (e.g., append) the relevancy information to the ad request 114A, 114B in the form of one or more relevancy tags (RTs) and forwards a resulting tagged ad request 126A, 126B, and 126C through the Internet 108 to an ad provider 134. “Ad provider” in this context may comprise a search engine, a content provider, or an ad broker receiving the tagged ad request 126A, 126B, 126C irrespective of whether the ad provider sources the ad. The RTs may comprise a uniform resource locator (URL) extension including one or more keywords, browsed content segments, or other indicia of a subscriber's interests, as previously mentioned.

Example embodiments may embed and communicate RTs in various ways using various protocols. Three example syntax methods, RT communication via HTTP headers, RT communication via content HTML/XML, and RT communication via URL, are illustrated below. Variations of these syntax arrangements may be combined into an ad transport protocol (ATP) used to tunnel ad communications within a standard network protocol. Some embodiments may utilize other communication methods including extensible markup language (XML), representational state transfer (REST), and/or simple object access protocol (SOAP).

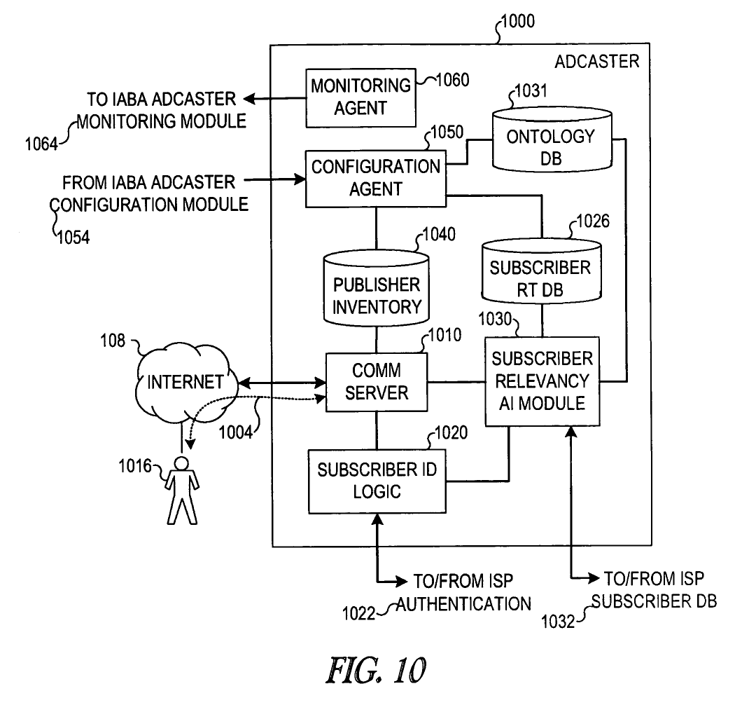

VIA HTTP HEADERS
Using also figure 11 as partial source of RTs
Extracting RTs for UID=10023 and Session A and C
GET /Any-Ad-Server/ HTTP/1.1
Host: www.Any-Ad-Publisher.com
Accept: text/html, text/plain
Accept-Language: en-us
X-Relevancy-Tags: UID=10023, Keywords=”Vacation Sun Spots”
X-Relevancy-Tags: Geo-Zip=91010, AI=Travel
X-Relevancy-Tags: Propensities=27,34,17
VIA CONTENT HTML or XML
Using also figure 11 as partial source of RTs
Extracting RTs for UID=10023 and Session A and C
GET /Any-Ad-Server/ HTTP/1.1
Host: www.Any-Ad-Publisher.com
Accept: text/html, text/plain
Accept-Language: en-us
<HTML>
<SCRIPT>
<Relevancy-Tags: UID=10023, Keywords=“Vacation Sun Spots”/>
<Relevancy-Tags: Geo-Zip=91010, AI=Travel />
<Relevancy-Tags: Propensities=27,34,17 />
</SCRIPT>
</HTML>
VIA URL
Using also figure 11 as partial source of RTs
Extracting RTs for UID=10023 and Session A and C
GET /Any-Ad-
Server/ParseAdTag?uid=10023&keywords=
Vacation%20%Sun%20%Spots&Geo-
Zip=91010&AI=Travel&Propensities-2734,17 HTTP/1.1
Accept-Language: en-us
VIA COOKIE
Get /Any-Ad-Server
Host: www.Any-Ad-Publisher.com
Cookie: {uid=10023, keywords=Vacation+20:Sun+20,Spots,Geo-
Zip=91010,AI=Travel+Propensities+2734,17}
Accept: text/html, text/plain

The ad provider 134 may use the RTs to find an appropriate ad based upon user relevancy information encapsulated in the RTs and may send the ad to the IACD 116 in a response 138A, 138B, and 138C. In some example embodiments the ad provider 134 may source the ad directly. In some example embodiments the ad provider may pass the tagged request 126C to an alternate ad provider 142 in the ad network 100. An alternate ad provider 142 may be communicatively coupled to the ad provider 134. A second alternate ad provider 144 may be communicatively coupled to the alternate ad provider 142. The alternate ad provider 142 may source the ad or pass the tagged request 126C to a second alternate ad provider 144. The second alternate ad provider 144 may source the ad or pass the tagged request 126C to another ad provider, and so on. Thus, in an example embodiment, the request 126C may be passed along serially to one or more ad providers based on an RT. When an ad provider capable of maximizing the ad opportunity is reached, that ad provider may provide an ad based on the RT.

The adcaster 106 may also remove an ad tag associated with any of the various responses received from the ad provider 134 and may replace the ad tag with an ad tag associated with an alternate ad provider 142. This process may serve to bypass one ad provider in favor of another. The adcaster 106 may also elect to make an out-of-line call to the ad provider 134 via a path 143. “Out-of-line call” means a communication other than standard HTTP request/response messages traversing the IACD 116 and associated with content and ad delivery to the IACD 116. The adcaster 106 may enhance the out-of-line call with RTs for the purpose of accounting for a new ad proposition by the ad provider 134.

In some example embodiments the adcaster 106 may source the ad directly. Alternatively or in addition, an internet advertising brokerage apparatus (IABA) 150 may optionally be communicatively coupled to the adcaster 106, to the alternate ad provider 142, and/or to the second alternate ad provider 144. The adcaster 106 may pass the tagged request 126A to the IABA 150.

It is noted that embodiments herein may use analytical mechanisms employing algebraic, statistical (e.g., parametric, non-parametric, basian), heuristic, and/or artificial intelligence (AI) based techniques to enhance relevancy information. Some descriptions herein may refer to “relevancy AI” mechanisms and techniques as examples and without limitation as to the applicability of alternate analytical techniques.

For example, the IABA 150 may enhance the RTs associated with the tagged request 126A using a relevancy artificial intelligence (AI) mechanism 154 to create additional relevancy information. The IABA 150 may receive RTs indicating that a subscriber is interested in automobiles, collectibles, and modeling. Using these inputs the AI mechanism 154 may generate the RT “antique model cars” as additional relevancy information.

In an example embodiment, the relevancy AI mechanism 154 may generate the additional relevancy information by analyzing search strings, search habits, internet access methods, and location-based demographics, and/or by performing ontology-based RT synthesis associated with individual subscribers or groups of subscribers as further described below. The IABA 150 may supplement the user information 122 with the additional relevancy information via a path 156.

The IABA 150 may select and source the ad directly using the enhanced RTs. Alternatively, a third-party ad provider 162 may be communicatively coupled to the IABA 150. The IABA 150 may pass an enhanced RT request 158 to the third-party ad provider 162. In some example embodiments the ad provider 134 may pass the tagged request 126C to the IABA 150. In the latter case the IABA 150 may source the ad directly, may pass the enhanced RT request 158A to the third-party ad provider 162 to source the ad, or may pass the enhanced RT request 158B to the ad provider 134 to source the ad. It is noted that in an example embodiment the IABA 150 may source the ad to the ad provider 134, to the alternate ad provider 142 or 144, to the adcaster 106, or directly to the IACD 116.

The IABA 150 may also communicate via an application programming interface (API) 163 provided by an ad provider (e.g., the ad provider 134) to request ad content. The IABA 150 may engage with the ad provider 134 in a concurrent plurality of such API communications in order to evaluate multiple ad content opportunities from multiple sources in real-time prior to delivering the ad content. These processes may result in relevant, high-value ad content being delivered to the IACD 116.

An example advertiser 166 may be communicatively coupled to the ad providers 134, 142, 144, 162, and/or to the IABA 150. The advertiser 166 may, for example, produce the ad and may contract with any of the ad providers 134, 142, 144, 162, and/or the IABA 150 to pay for delivery of the ad to the IACD 116. In some example embodiments the advertiser 166 may pay a differential premium price for delivery of the ad to the IACD 116 based upon a level of interest imputed to the subscriber 118 based upon RTs and/or enhanced RTs. For example, an advertiser of antique model cars who may ordinarily pay ten cents for an ad placement may pay fifty cents for an ad placement to a subscriber known or suspected of being specifically interested in antique model cars.

FIG. 1A is a sequence diagram illustrating an example ad delivery method as previously described. The initial HTTP request/response sequence 174 is exchanged between the IACD 176 and the content publisher 178 as it is passed through by the adcaster 180. The RT-enhanced web request 182 is, however, redirected by the adcaster 180 to the IABA 184. The IABA 184 may further enhance the request 182 and analyzes ad placement opportunities that may exist as a result of the request 182. As part of the analysis the IABA 184 may engage with the content publisher 178 in a series of negotiation exchanges 186. Following the analysis the IABA 184 may send a “bid” message 188 to the content publisher requesting authorization to place an ad in response to the ad request. Alternatively the IABA 184 may pass the ad request on to the content provider or to another participant in the ad network for fulfillment of the ad placement opportunity generated by the request 182.

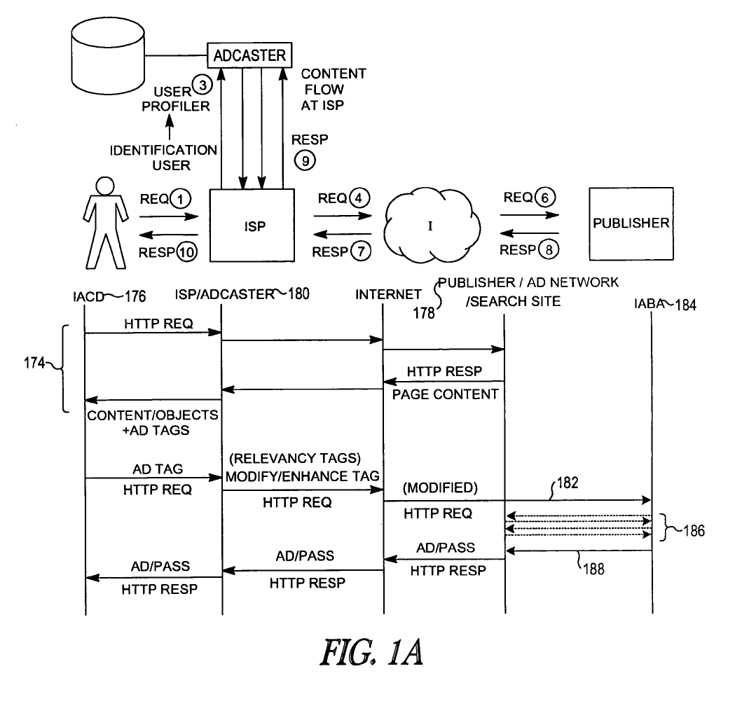

FIG. 2 is a block diagram of an internet advertising network 200 communicatively coupled to and serving an aggregation of ISPs of various types (e.g., first, second, and Nth ISPs 214, 226, and 238, respectively) according to various example embodiments. In the example internet advertising network 200 the IABA 232 services operations, data collection, reporting, and ad trafficking of the ISPs 214, 226, 238. An ad provider 242 and/or an advertiser 246 may be coupled to the IABA 232. In an example embodiment, the IABA 232 enables the advertiser 246 and/or the ad provider 242 to reach a plurality of subscribers (e.g., the subscribers 210, 222, and 236) with targeted ads by delivering subscriber requirements to the ad provider 242 and/or the advertiser 246.

The first ISP 214 may be communicatively coupled to the IABA 232 and/or to the ad provider 242. A first plurality of adcasters 206 may be communicatively coupled to the first ISP 214. A first plurality of IACDs 208 may also be communicatively coupled to the first ISP 214. The first plurality of adcasters 206 may receive redirected requests from the first plurality of IACDs 208 associated with a first plurality of subscribers 210 via the first ISP 214. A second plurality of adcasters 218 may receive redirected requests from a second plurality of IACDS 220 associated with a second plurality of subscribers 222 via the second ISP 226, and so on including an Nth plurality of adcasters 218 receiving redirected requests from an Nth plurality of IACDs 234 associated with an Nth plurality of subscribers 222 via the Nth ISP 226. Example embodiments herein may aggregate any number of ISP/adcaster groupings.

The IABA 232 may receive a tagged request 233 from one or more of the plurality of adcasters 206, 218, or 230. The IABA 232 may select one or more enhanced RTs (e.g., “antique model cars”) from an enhanced RT database 250 associated with the IABA 232. The enhanced RT database 250 may be populated using the relevancy AI mechanism 154 of FIG. 1 as previously described.

The IABA 232 may also track successful and unsuccessful ad placement requests. A successful ad placement request occurs if the IABA 232 detects an ad placement opportunity, communicates an offer to a content provider or ad broker to place an ad, and the offer is accepted. The mechanisms underlying these operations are described in detail below.

The AI mechanism 154 may extract trends and may associate RTs with high-value trafficable ad opportunities. The resulting enhanced RT database 250 may thus comprise a consolidation of RTs from the aggregation of adcasters 206, 213, and 230 and may also include additional RTs synthesized by the relevancy AI mechanism 154. As the IABA 232 receives information across a plurality of ISP networks and from a plurality of subscribers associated with each ISP, aggregated data may be processed to provide enhanced RTs.

The aggregation and trending of relevancy information may also be used to enhance the relevancy AI mechanism may itself. The AI mechanism 154 may observe that ads chosen based upon a particular set of enhanced RTs result in a high rate of successful ad placements at a high profit margin. For example, the AI mechanism 154 may observe that the use of the RT “antique model cars” (generated perhaps in response to a subscriber browsing automobiles, collectibles, and modeling) to select an ad for model cars results in a high rate of successful ad placements across the plurality of ISP networks. Example embodiments may use such trending as a feedback mechanism within the relevancy AI mechanism to increase the strength of association between an original set of RTs and an enhanced set of RTs.

The enhanced RT database 250 may be used by the IABA 232 to select an ad to source. Alternatively the enhanced RTs may be passed to the ad provider 242 to source the ad as previously mentioned and as described in detail below. The advertiser 246 may produce the ad and/or may contract with the IABA 232 or with the ad provider 242 to deliver the ad to the requesting one of the IACDs 208, 220, or 234.

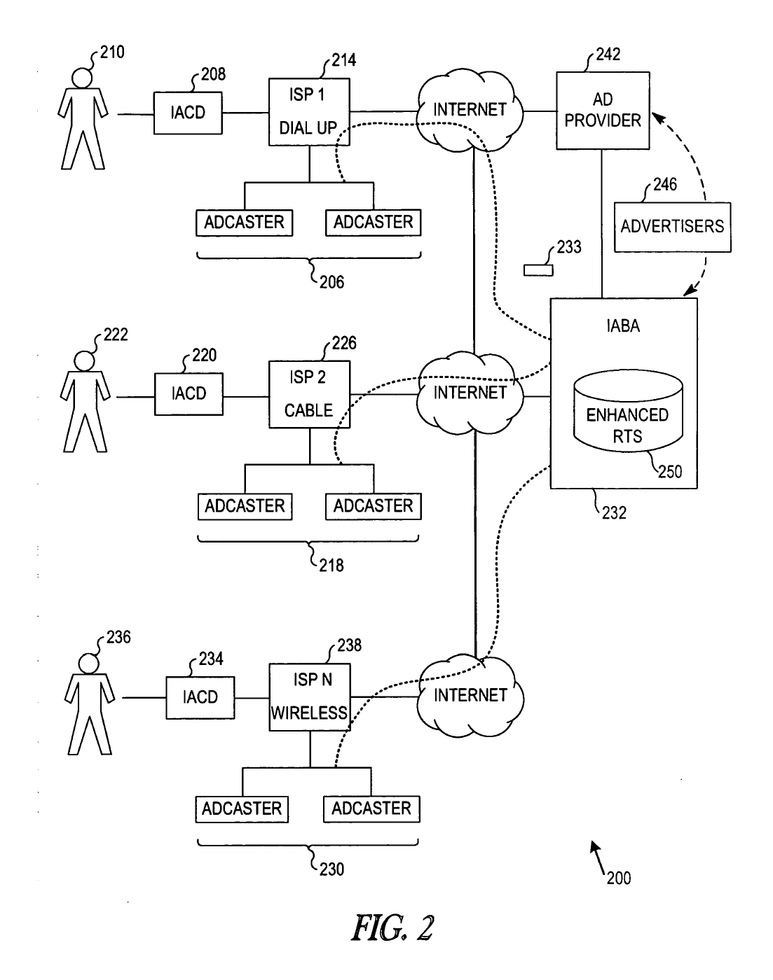

FIG. 3 is a block diagram of an internet advertising network 300 including a tiered internet provider network according to various example embodiments. One or more ISPs 306 may purchase internet bandwidth from one or more upstream providers 310. The upstream providers 310 may comprise tier 3 providers in some cases.

One or more adcasters 314 may be communicatively coupled to one or more of the upstream providers 310. A request 318A, 318B, and 318C may be generated by an IACD 322 associated with a subscriber 326. The request 318A, 318B, and 318C may be routed to the adcasters 314 via cooperative arrangements and protocols through networks associated with the ISPs 306 and the upstream providers 310.

One or more upstream providers 310 may provide peering routes or other routing policies to send ad data packets to the IABA 338 for enhancement. Such methods may enable the downstream ISPs 306 to monetize ad traffic to and from subscribers (e.g., the subscriber 326). A communications entity through which HTTP website advertising passes monetizes ad traffic when that entity realizes monetary gain from the ad traffic. Typically monetization becomes possible when the communications entity adds value by enhancing the advertising system in some way. Example embodiments described herein enable the monetization of add traffic by adding value in the form of the capture, creation, and routing of RTs. The upstream providers 310 may route the ad data packets to each of their downstream ISPs 306 individually, or they may route any portion or all downstream traffic to the ISPs 306 by any other methods available from within their infrastructure.

The adcasters 314 may analyze a data stream associated with the request 318C and may access subscriber information from a subscriber information source 330. The subscriber information source 330 may comprise subscriber information made available by the ISPs 306 or may comprise some other source of subscriber information. Viewing FIG. 3 in light of FIG. 2, subscriber information may, for example, be derived from an ISP provisioning method. A dial-up subscriber may be associated with lower data rate content and may be geographically localized according to a telephone prefix (e.g., the telephone prefix “408” associated with San Jose, Calif. A static “dial-up” RT and a dynamic telephone prefix indicator may identify subscribers originating from the ISP 214. Various types of customizable RT information may identify various provisioning methods used by the ISP 214.

Using information derived from the data stream analysis and from the subscriber information source 330, the adcasters 314 may append appropriate RTs to the request 318C and forward a corresponding tagged request 334 to an IABA 338 as previously described by way of example.

The IABA 338 may select one or more enhanced RTs from an enhanced RT database 342 associated with the IABA 338 as previously described. The enhanced RTs may be used to select an ad for sourcing from the IABA 338 or may be passed to another ad source 346 to be used by the other ad source 346 to select an ad. An advertiser 350 may produce the ad and/or may contract with the IABA 338, with the ad source 346, or with both to deliver the ad to the IACD 322.

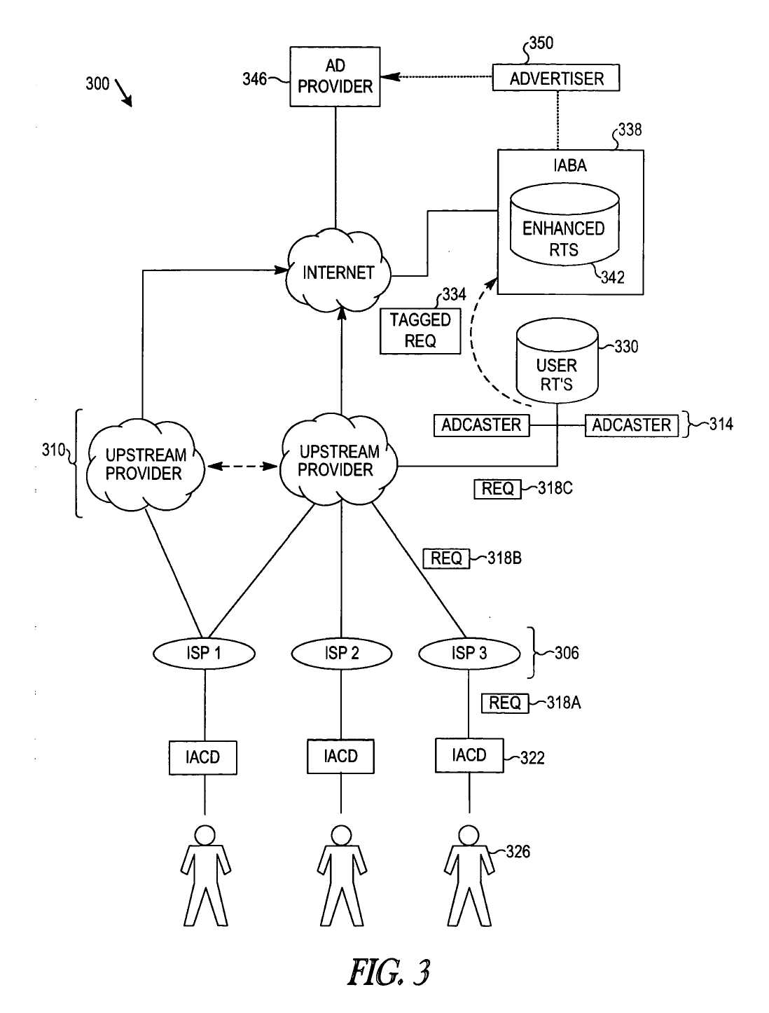

FIG. 4 is a block diagram of an internet advertising network 400 including an internet hosted services environment according to various example embodiments. In this example embodiment, one or more ISPs 404, 406, 408, and 410 may provide internet access service to a subscriber 414 at an IACD 416. The ISPs 406, 408, and 410 may purchase internet bandwidth from an upstream provider 418.

A contractor for enhanced ad delivery service may contract with an upstream provider 422 to locate one or more adcasters 428 at an operations facility associated with the upstream provider 422. The contractor may also contract with the ISP 406 directly and may route outbound internet request packets 432A, 432B, 432C, and 432D to the adcasters 428 through the Internet 108.

The adcasters 428 may extract relevancy information (e.g., “automobiles,” “collectibles,” and “modeling”) from the subscriber internet request packets 432A, 432B, 432C, 432D and/or may receive subscriber information (e.g., age, gender, zip code) made available to the adcasters 428, as previously described by way of example. The adcasters 428 may then append RTs corresponding to the relevancy information to outbound request packets and forward the resulting tagged requests 434A and 434B through the Internet 108 to an ad provider 440 and/or to an IABA 444. The IABA 444 may enhance the RTs and sell the enhanced RTs (e.g., “antique model cars”) and/or use the enhanced RTs to select an ad, as previously mentioned and as described by way of example below.

In some example embodiments the upstream providers 422 and 418 may provide alternate paths (e.g., an alternate path 450) to route data streams from the ISPs 404, 406, 408, and 410. Alternatively, or in addition, the ISP 406 may deliver RTs via a dedicated link 456. Such alternate paths and dedicated links may be referred to herein as “out-of-band” communications. Packets associated with RT enhancement functionality supplied by the IABA 444 may continue to traverse the Internet 108.

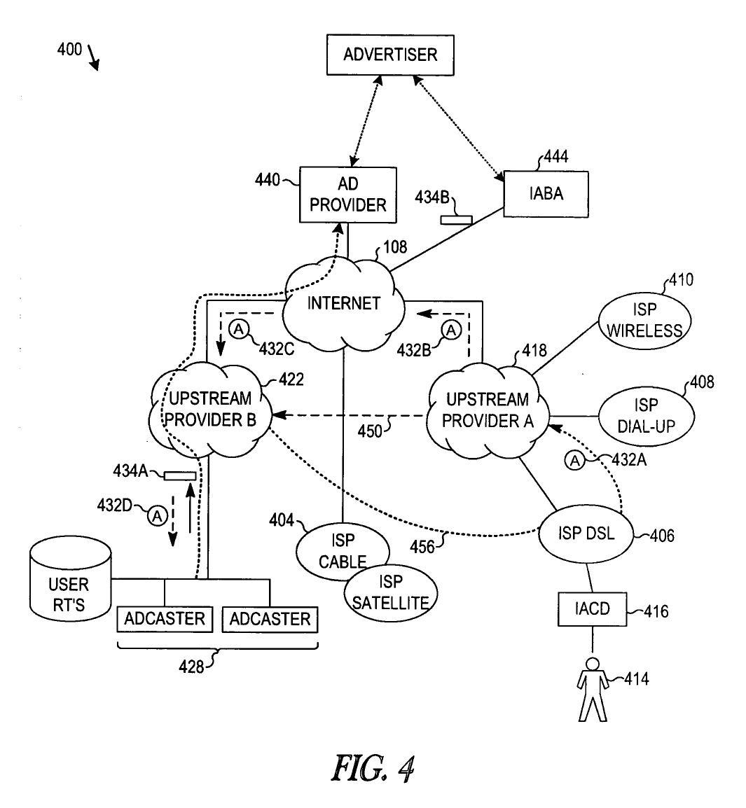

FIG. 5 is a block diagram of an internet advertising network 500 including an internet third-party services environment according to various example embodiments. A third-party service provider 506 may provide an internet-based service to a subscriber 510 accessing the Internet 108 via an ISP 518 (and optionally via an upstream provider 522 in some example embodiments). The third-party service provider 506 may provision services directly with the subscriber 510 or may be contracted as a service that is provisioned through the ISP 518. Examples of the internet-based service may include browsing acceleration services, security filtering, parental blocking, spyware detection and removal, phishing notifications, ad blocking, email services, and/or application hosting services, among others.

In some example embodiments the third party service may be provided by the upstream provider 522 or by any entity in a chain of providers providing internet bandwidth. Applications, communications facilities, and/or serving facilities associated with the third-party services provider 506 (e.g., servers, routers, and gateways, among others) may interface to one or more adcasters 526. In some example embodiments the interface may comprise an application programming interface (API).

The third-party services provider 506 may receive ad request packets 528 associated with requests for the internet-based service. The third-party services provider 506 may compile relevancy information associated with interests and/or profiles associated with the subscriber 510. The relevancy information may be compiled from registration sessions conducted when the subscriber 510 registers (e.g., fills out an online registration form) for the internet-based service. The relevancy information may also be compiled from a data stream associated with subscriber interaction with the service provider 510's internet-based service and/or may be received from the ISP 518 as subscriber data 530. In some example embodiments the subscriber relevancy information may be stored in a subscriber information database 534 associated with the adcasters 526.

In an example embodiment the adcasters 526 may append some portion of the user relevancy information as RTs to the ad request packets 528 and send corresponding RT-tagged ad request packets 538A, 538B, and 538C to an ad provider 542 and/or to an IABA 546. The IABA 546 may enhance the RTs and sell the enhanced RTs to an advertiser or to an ad provider. The IABA 546 may also use the enhanced RTs to select an ad, as previously mentioned and as described in detail further below.

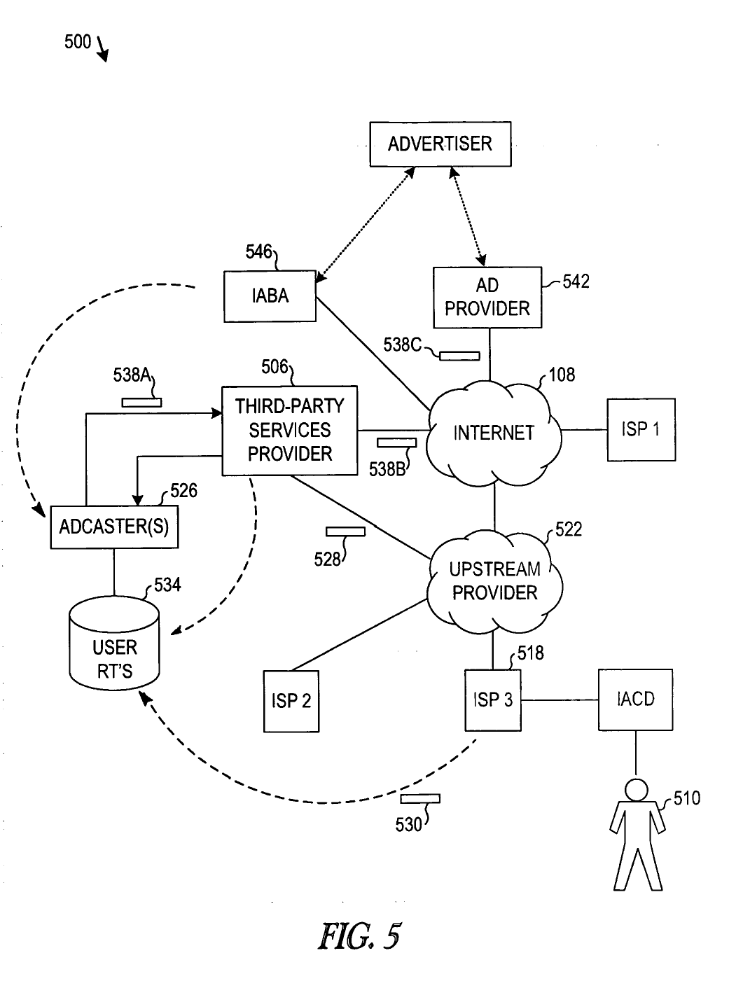

FIG. 6 is a block diagram of an internet advertising network 600 enabled using an IACD 610 according to various example embodiments. The IACD 610 may comprise a desktop computer, a laptop computer, a hand-held computer, a web-enable cellular telephone, or any other computing device. The IACD 610 is communicatively coupled to an ISP 614 to serve a subscriber 618.

A cooperative software agent 622 may be resident on the IACD 610. The cooperative software agent 622 may comprise a stand-alone application or may be associated with an operating system 623, with a software plug-in, with a programming API capable of integration into a software application, with programmable browsing scripts consumed by a browser 624, with the browser 624 itself, or with a search tool 625, among other example associated software modules.

The cooperative software agent 622 may receive additional information imputed by the subscriber 618. The software agent 622 may also use information derived between the agent 622 and the IACD 610, including user identifiers such as MAC addresses, CPU serial numbers, desktop information, information from the O/S 623, or from the cooperation between applications running on the IACD 610. The aforesaid additional information may include data that might not be otherwise available to the adcaster 628 due to its upstream proximity away from the subscriber 618.

The software agent 622 may communicate with one or more adcasters 628 to provide user relevancy information 630 to the adcasters 628. The software agent 622 is termed “cooperative” because it cooperates with the adcasters 628. The user relevancy information 630 may traverse a path 631 and may be stored in an RT database 632 associated with the adcasters 628 in some example embodiments. Although the example embodiment shows the adcasters 628 coupled to an upstream provider 633, it is noted that the adcasters 628 may be coupled to a network at various nodes in the network.

The software agent 622 may cause user internet requests 636A and 636B to be routed to the adcasters 628 for RT tagging according to routing and tagging operations previously described. The adcasters 628 may route RT-tagged ad request packets 640A, 640B, 640C, 640D, and 640E to an ad provider 644 and/or to an IABA 650, either directly or via the IACD 610. The adcasters 628 may enhance the RTs. The IABA 650 may also enhance the RTs and sell the enhanced RTs and/or use the enhanced RTs to select an ad, as previously mentioned and as described in detail below.

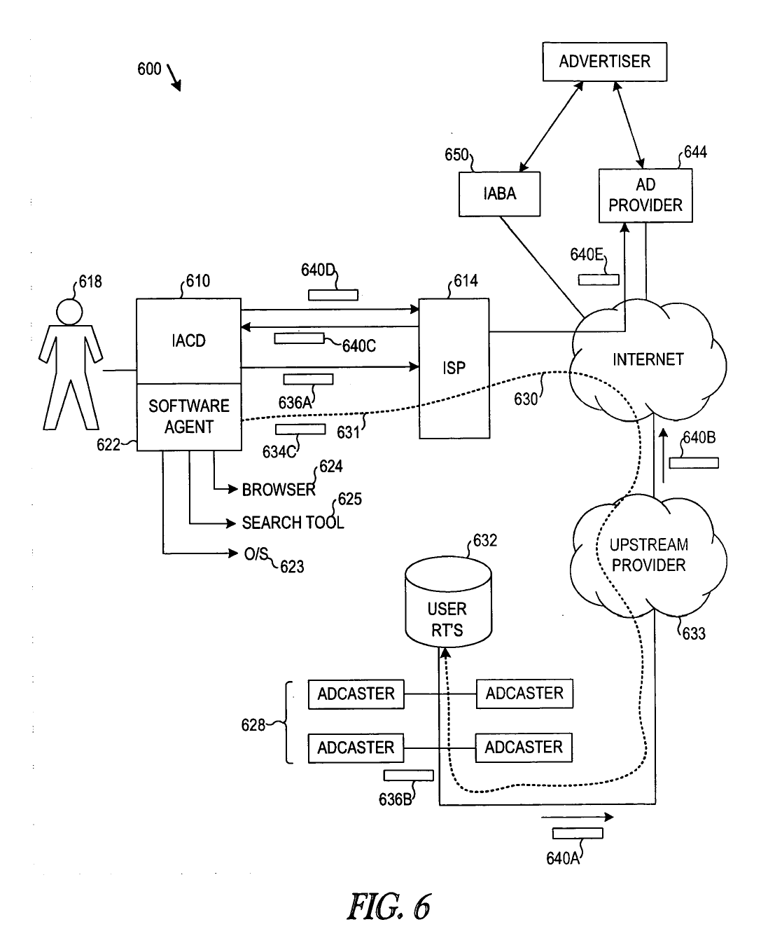

FIGS. 7A and 7B are block diagrams illustrating closely-coupled and embedded adcasters according to various example embodiments. In both cases the adcasters intercept requests, including ad requests, from one or more subscribers and tag the requests with RTs representing information about the subscribers. Thus tagged, the ad requests enable an ad provider to supply an ad targeted to particular subscriber interests and profiles.

Turning to FIG. 7A, an ad request 706A may originate at an IACD 710 associated with a subscriber 714. The ad request 706 may comprise an HTTP request or other mechanism (e.g., REST, internet content adaptation protocol (ICAP), and/or WCCP) riding at the application layer of a TCP/IP packet according to known protocol structures. An application process may be operated cooperatively with an adcaster 724 to pass the ad request 706A to the adcaster 724 as ad request 706B. The application process 720 and the adcaster 724 may communicate via one or more interprocess communication (IPC) schemes including APIs. In some example embodiments the application process may thus strip away lower-level protocol information from the ad request 706A and pass only the HTTP portion of the ad request 706A to the adcaster 724 as the ad request 706B.

In another example embodiment the application process 720 may reduce the number and size of data packets being sent to the adcaster 724. This may be accomplished by increasing the transmission efficiency of the data stream associated with the IACD 710 using HTTP data compression methods.

The application process 720 may execute on a server, on a specialty hardware device, on a network interface card (NIC), on a proxy server, on a network gateway, on a traffic service gateway, on a packet inspection device, on a switch, and/or on a router. The application process 720 may also be associated with a NIC driver or with deep packet inspection software and may interoperate with the adcaster 724 as described above.

The adcaster 724 may tag the ad request 706B with one or more RTs and may pass the resulting tagged ad request 728 across a communications path back to the application process 720. In some embodiments the communications path may comprise an IPC link, as previously mentioned. Example embodiments herein may refer to an “IPC” link or interface without loss of generality. The application process 720 may then re-encapsulate the tagged ad request 728 and send a TCP/IP-encapsulated tagged ad request 734 through the Internet 108 an ad provider 742 or to an IABA 746. This or similar architecture may be employed in the internet advertising network illustrated in FIG. 5 above.

Turning to FIG. 7B, an ad request 750A and 750B may originate at an IACD 754 associated with a subscriber 758. An adcaster 762 may be embedded in a packet communication device (PCD) 766. The embedded adcaster 762 may comprise a software module, one or more circuit boards, one or more integrated circuits, programmable integrated chips, or a combination thereof. The PCD 766 may comprise a wired or wireless switch, a router, a gateway, a firewall, a deep packet inspection device, or some other PCD. A specially-designed network interface card (NIC) and/or a customized NIC device driver may be included as a component of the PCD 766 in some example embodiments.

The PCD 766 may pass the ad request 750A, 750B to the embedded adcaster 762. The adcaster 762 may return a tagged ad request 770A and 770B via IPC or other hardware or software interface. As described with reference to FIG. 7A, the PCD 766 may be used alone or in conjunction with other packet communication devices to reduce the number and/or size of data packets sent to the embedded adcaster 762. Example embodiments herein may more efficiently deliver a subscriber data stream as a result.

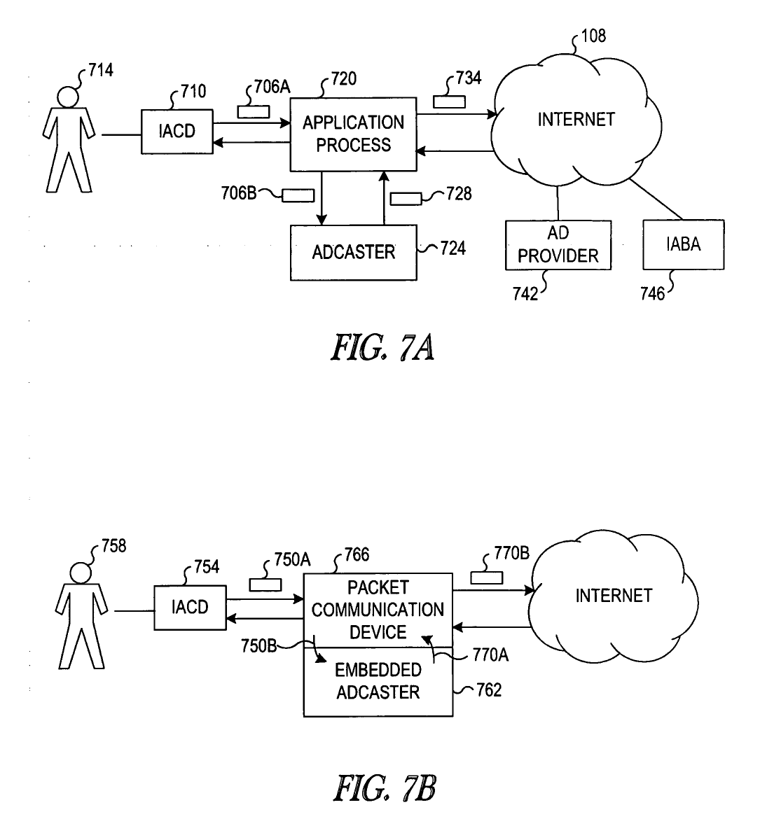

FIG. 8 is a block diagram of an internet advertising network 800 including a hierarchy of internet advertising brokerage apparatus (IABAs) according to various example embodiments. Each IABA works cooperatively with a plurality of adcasters (e.g., the adcasters 814) to receive RT-tagged ad requests, to enhance RTs associated with the ad requests, to pass the enhanced RTs to other entities for ad sourcing, and/or to source ads appropriate to the enhanced RTs from the IABA.

Some example embodiments may include one or more IABAs dedicated to interoperate with adcasters serving subscribers located in particular areas of the world. For example, in North America 818 a U.S. West Coast IABA 820 may interoperate with an adcaster (e.g., the adcaster 844) connecting an ISP 828 serving subscribers 834. One or more IABAs 838 may enhance RTs associated with subscribers in Europe 844. An IABA 850 may enhance RTs associated with subscribers in India 854, and so on.

Some example embodiments may include a master IABA 860. The IABA 860 may collect performance data and operational statistics from the various IABAs serving various geographical areas. The performance data and operational statistics may be stored on a data store 866 for later interpretation and analysis. Some example embodiments may also include a performance feedback module 870. The performance feedback module 870 adjusts operational parameters associated with IABAs aggregated under the master IABA 860 (e.g., the IABA 850). The operational parameters are adjusted for a particular IABA to drive operational statistic associated with the IABA toward a preselected set of values.

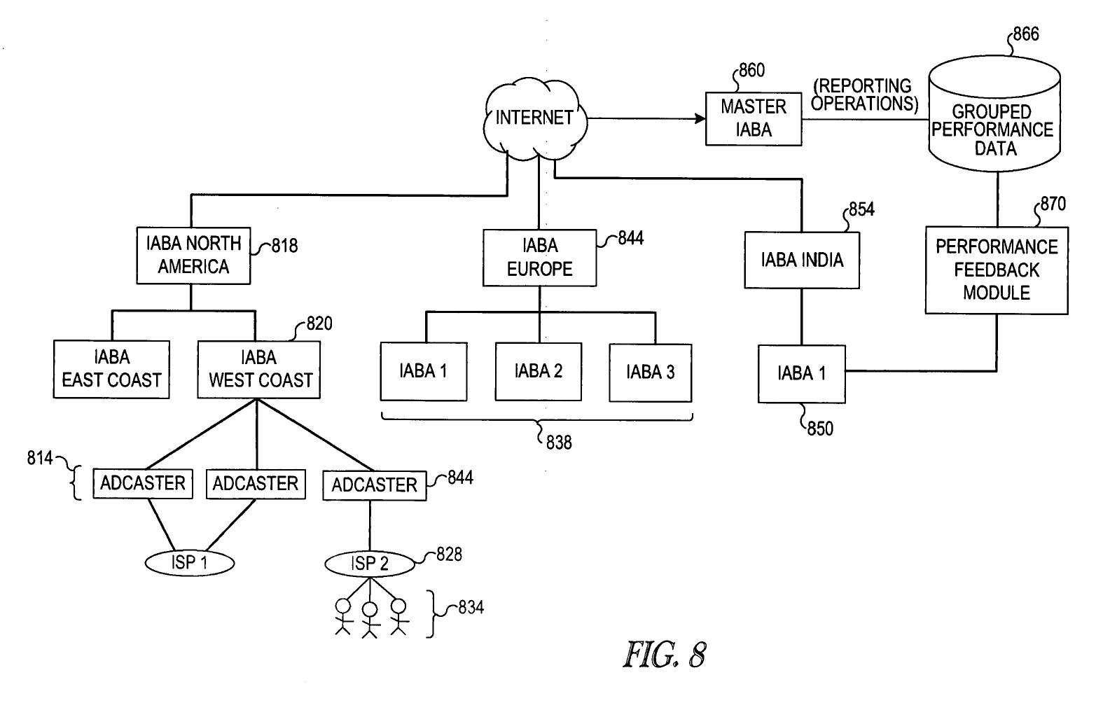

FIG. 9 is a block diagram of an internet advertising network 900 illustrating functional interaction between an internet advertising brokerage apparatus (IABA) 910 and an internet access stream intercept device (adcaster) 916 according to various example embodiments.

The IABA 910 may function as a controller of a plurality of adcasters such as the adcaster 916. As such, the IABA 910 may configure the adcaster 916 via a path 920. This configuration may include methods to secure transmissions between the IABA 910 and the adcaster 916. Configuration operations may include downloading publisher inventory database updates and settings used to configure classes of service. Examples of such settings are provided in detail below. Groups of subscribers may use settings customized for inter-operation with a particular ISP. The settings may be used to turn on or off types of advertising such as inserting new ads into website “white-space” or setting frequency or capping parameters associated with quantities of ad placements delivered to an ISP by the TABA 910. Settings may also be used to indicate a type of network connectivity. For example, an ISP may use network connectivity settings to enable more advertising deliveries to a free wireless network and may enable a lower delivery rate to a paid broadband business network. Exclusion rules may also be configured in cases where advertiser or publishers object to the operations associated with the IABA 910. The afore-mentioned are merely examples of many advertising policies, ISP provisioning information, and configuration services that may be transmitted by the IABA 910 to the adcaster 916.

The publisher inventory database may thus include lists of ad providers, one or more URLs associated with each ad provider, and one or more ad delivery mode indicators associated with each ad provider. An ad delivery mode indicator specifies which of several ad delivery methods a particular ad provider is capable of executing. The adcaster 916 may choose to employ some, all, or none of these delivery methods.

The adcaster 916 may also report status information and performance statistics via a path 924. Status information may include real-time operational checks from the adcaster 916. These may include memory, disk space, and CPU utilization, among others. Performance tracking may include real-time access to ad flow rates (e.g., a number of ads flowing per second as sources by the IABA 910 or by a third-party ad provider), a number of user sessions online at a specified point in time, and a number or rate of accepted and rejected ad bids, among others.

The adcaster 916 may also send non-personally identifiable information (PII) in RTs to the IABA 910 along a path 928 in order to populate an RT database on the IABA 910.

As an IABA, the IABA 910 is positioned at a hierarchically superior network position to that of the adcaster 916. More specifically, the IABA 910 may interact with and collect RTs from multiple adcasters. From this vantage point, the IABA 910 may develop and maintain statistical trends related to RTs. Such statistical trends may include ad placement costs and success rates associated with various ads, advertisers, and ad providers, among others.

The adcaster 916 may avail itself of the resources maintained by the IABA 910 by sending an ad proposition inquiry via a path 936. The IABA 910 may respond to the inquiry via a path 940 with an instruction as to which of several ad delivery methods to use to place the ad. Alternatively the IABA 910 may respond with an instruction to refrain from placing the ad. These methods and modes of operation are explained in further detail below.

In addition to providing guidance to the adcaster 916 as to a preferred mode of ad placement, the IABA 910 may also perform ad brokering transactions 944 associated with the ad placement. Such transactions may include offering targeted ad opportunities to ad providers for a premium price and selecting times for ad delivery when a target subscriber is browsing content from a publisher with a low ad-space cost basis.

### Adcaster Architecture

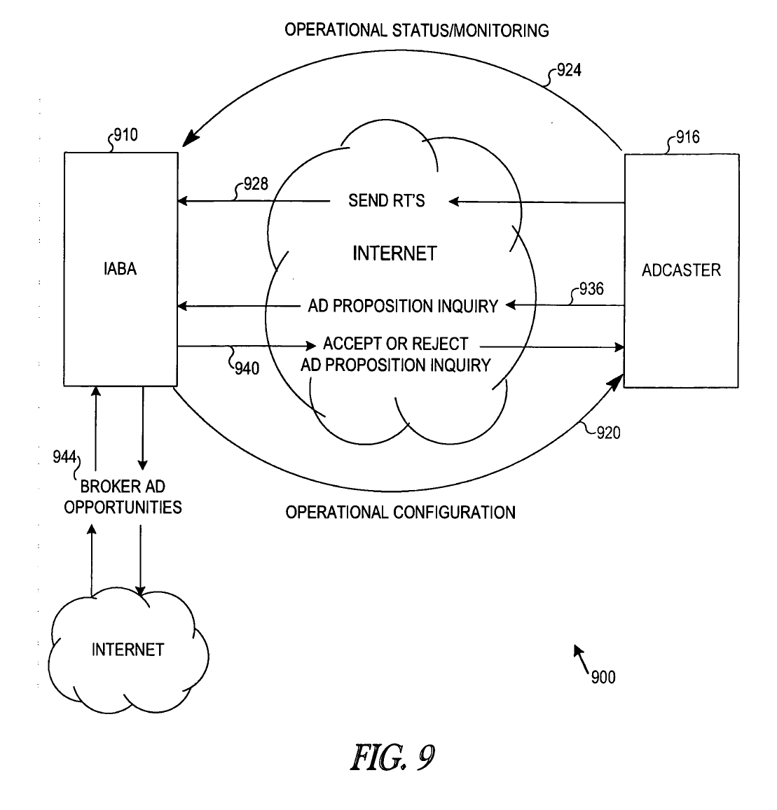

FIG. 10 is a block diagram of an adcaster according to various example embodiments. The adcaster 1000 is strategically positioned in a network with the necessary permissions so as to be in a logical path of a subscriber data stream 1004. The adcaster 1000 monitors the subscriber data stream 1004 for ad requests and responses and inserts RTs into the requests and/or responses. The adcaster may modify the subscriber data stream 1004 to accommodate RTs or other communication elements related to ad placement opportunities. The subscriber data stream 1004 may also be modified to perform value-added services, to enable subscriber communications and/or network-based application services. The RTs are used by the ad network to better target internet ads to subscriber interests, as previously described.

The adcaster 1000 may comprise a communication server 1010. The communication server 1010 implements packet communications to and from the Internet 108. The adcaster 1000 communicates with a variety of ad network entities using the communication server 1010, including a plurality of subscribers (e.g., the subscriber 1016), one or more ISP infrastructure devices such as a vectoring-enabled network switch (e.g., a layer four switch) or router, one or more ad providers, one or more advertisers, and/or an IABA. In some example embodiments the communication server 1010 may also be API-enabled. In the latter case the communication server 1010 may communicate with one or more of the above-mentioned devices via an interprocess communication protocol and/or link.

The adcaster 1000 may also include subscriber identification (ID) logic 1020 coupled to the communication server 1010. The subscriber ID logic 1020 interfaces with an ISP authentication mechanism, including but not limited to an authentication, authorization, and accounting (AAA) service. The AAA service may be implemented with a remote authentication dial-in user service (RADIUS) server, a dynamic host configuration protocol (DHCP) server, a Kerberos server, or a terminal access controller access-control system (TACACS) server, among other authentication devices and protocols. The subscriber ID logic 1020 may itself comprise an authentication mechanism including one or more of the aforementioned authentication mechanisms.

The subscriber ID logic 1020 identifies the subscriber 1016 and the user session associated with the subscriber data stream 1004. Identification logic may identify multiple user sessions associated with a single subscriber account. Distinguishing a particular user may be important because an ad placement opportunity may be valued according to the degree to which RTs are pinpointed to the interests of a particular user.

The adcaster 1000 may further include a subscriber relevancy AI module 1030 coupled to the communication server 1010. Having identified the subscriber 1016, the adcaster 1000 uses the subscriber relevancy AI module 1030 to create RTs associated with the subscriber 1016. The RTs may be created from relevancy information harvested from the subscriber data stream 1004, from an ISP subscriber database 1032, from internet connection provisioning information associated with the subscriber 1016, and/or from any other relevancy information discernible by the subscriber relevancy AI module 1030. The RTs are stored in a subscriber RT database 1026.

The subscriber relevancy AI module 1030 may also perform ontology-based RT synthesis operations associated with individual subscribers or groups of subscribers. The subscriber relevancy AI module 1030 performs searches of an ontology database 1031 for one or more keyword RTs and/or key phrase RTs and adds keywords and key phrases from the returned results as additional keyword RTs to the subscriber RT database 1026. This process is described in detail further below.

Subscriber relevancy AI modules associated with a group of adcasters may be selectively programmed to operate independently or to interoperate in order to serve the needs of various types of ISPs.

FIG. 11 is a set of RT records 1100 associated with the subscriber RT database 1026 according to various example embodiments. Considering FIG. 11 in view of FIG. 10, the adcaster 1000 engages subscriber ID logic 1020 to assign a user identification (UID) 1102 based upon the afore-mentioned example authentication process and upon information in a browser data stream. In a simple example embodiment the UID 1102 identifies an IACD to which a particular internet protocol (IP) address is assigned. More complex example embodiments may assign UIDs based upon browsing history. The latter complex example embodiments may discriminate between multiple users sharing a single IACD and/or between users who roam between multiple IACDs.

FIG. 11A is a block diagram showing a mechanism for pinpointing individual users associated with a shared computer according to various example embodiments. Multiple HTTP request data streams are sent from an IACD 1103. A first HTTP request 1104A and 1104B is associated with a browsing session conducted by a first user 1105. A second HTTP request 1106A and 1106B is associated with a browsing session conducted by a second user 1107 following a session break 1108.

The session break 1108 causes a break in time 1109 between the first HTTP request 1104B and the second HTTP request 1106B. An adcaster 1110 senses the break in time 1109 between the first HTTP request 1104B and the second HTTP request 1106B and flushes a user ID cache 1111. This may cause one or more RTs associated with the affected user browsing session to expire in the subscriber RT database 1026. Alternatively, or in addition, this mechanism may be used in conjunction with the trending of browsing patterns to link together expired browsing sessions. RTs associated with the linked browsing sessions may be accumulated for analysis and enhancement.

Turning back to FIG. 11, a session ID 1116 denotes temporal boundaries between groups of browsing activities. Thus, the subscriber RT database 1026 may associate the RTs “travel” 1118 and “zipcode=91010” 1119 with a user 10023 during a browsing session A 1120. Following a prescribed period of browsing inactivity, however, example embodiments herein may close the browsing session A 1120. Subsequent browsing activities by a user associated with the UID 10023 1117 may result in the assignment by the subscriber relevancy AI module 1030 of a new session ID C 1121.

The example set of RT records 1100 may also include an RT source field 1122. The RT source field 1122 indicates a functional origin of the associated RT. For example, the RT “travel” 1118 associated with the session ID A 1120 conducted by the UID 10023 1117 originated from relevancy artificial intelligence (AI) structures associated with a controlling IABA.

The example set of RT records 1100 may also include the RT field 1130 and an RT literal field 1138. Some categories of RTs may require the literal field 1138 as a further defining tag for completeness. For example, the RT literal “91010” is associated with the RT “zipcode” to yield a compound RT of “zipcode=91010” 1119.

A “propensity” field 1146 may also be included in the example set of RT records 1100. The propensity field 1146 is populated with a value corresponding to a relevancy metric. The propensity relevancy metric value is used by example embodiments herein to select the most relevant RTs. The latter process may result in delivery of highly relevant, high-value ads. The propensity relevancy metric value may be calculated using various relevancy criteria. Some example embodiments may calculate the metric value as follows:

Propensity=# of hits*taxonomy level*popularity

Other embodiments may calculate propensity using other algebraic, statistical, and/or heuristic methods.

The number of hits corresponds to a count of the number of occurrences of the RT in the browsing stream of the user for whom the propensity value is being calculated. This is a count maintained by the subscriber relevancy AI module 1030. The taxonomy level corresponds to a position down from the top of a keyword taxonomy tree where the RT is found. This process is described in further detail below. The popularity factor is a metric based on the occurrence of a keyword associated with the RT in browser streams associated with a population of users. The popularity factor may comprise a count kept by the subscriber relevancy AI module 1030, by relevancy AI structures associated with a controlling IABA, or by some other entity external to the adcaster 1000.

Some embodiments may write a record creation date/time field 1150 as the record is written. In order to enhance privacy and to conserve storage space, some example embodiments may cause records associated with the subscriber RT database 1026 to expire after a selected amount of time and/or upon sensing a selected event. Selected events may include a session expiration or a logoff, among other events. Some example embodiments may support the expiration of RT records by class of RT. That is, some RTs may be designated as more persistent than others. Some RTs may be designated as static, without expiration. Some example embodiments may include an expiration field in the RT record to provide for expiration of RTs on an individual basis. Subscriber RT database record expiration policies may be established as part of an adcaster configuration operation. In some example embodiments an adcaster configuration load set may be downloaded to the adcaster from the controlling IABA.

FIG. 11B is a block diagram showing a mechanism for pinpointing an individual user and an IACD associated with the individual user in a shared-IP environment according to various example embodiments. A first user 1160 browses at a first IACD 1162. A second user 1164 browses at a second IACD 1166. A third user 1168 browses at a third IACD 1170. All three IACDs 1162, 1166, and 1170 are connected to an ISP 1174 via a firewall 1176.

The firewall 1176 may operate according to a network address translation (NAT) protocol. That is, the local IP addresses associated with the IACDs 1162, 1166, and 1170 are all translated by the NAT software agent to the IP address of the firewall 1176 and inserted as the source address in IP packets outbound from the firewall 1176. An ambiguity thus arises as to the specific user associated with a particular HTTP request. The ambiguity is resolved, however, because the NAT agent also translates the unique TCP port number assigned to each IACD to a different TCP port number specific to each IACD. The latter TCP port number is unique to a particular user when combined with the external IP address of the firewall 1176.

Other data in the browsing stream that may be used to identify a particular user may include an authentication ID generated by an authentication process executed by the ISP and/or by an adcaster, a user agent identifier (e.g., “MSN” or “mozilla”), and/or a language identifier (e.g., “get/yahoo.com” or “get/apple.com”).

Turning back to FIG. 10, the adcaster 1000 may also comprise a publisher inventory database 1040 coupled to the communication server 1010. The publisher inventory database 1040 includes information to link website publisher ad space to RTs selected by the subscriber relevancy AI module 1030.

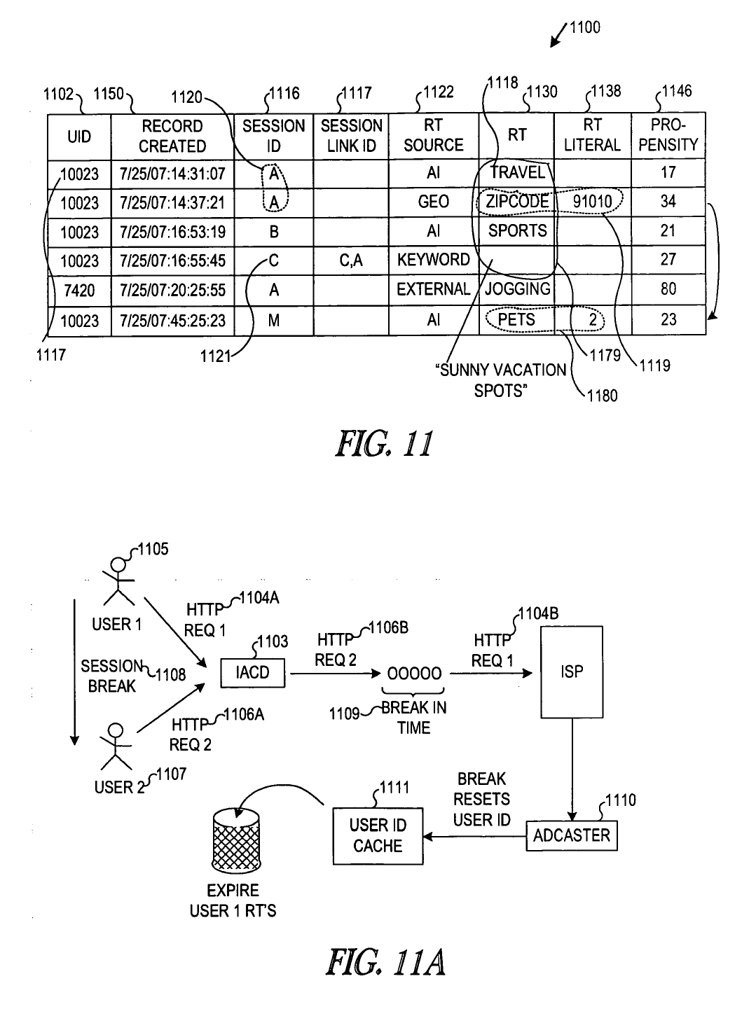

FIG. 12 is an example field layout diagram of a record 1200 associated with the publisher inventory database 1040 according to various example embodiments. The example record 1200 may include a publisher code 1210 to link attributes associated with an ad placement opportunity to a particular web publisher. The record 1200 may also include a billing terms field 1220 and an acquisition mode flag 1230. The acquisition mode flag 1230 indicates whether the publisher associated with the publisher code 1210 supports a price bid mode of operation or is limited to fixed-cost bidding.

The record 1200 may also include an asking price 1240 for the ad space represented by the record 1200. A size and position field 1250 identifies space parameters used to match an ad to the ad space represented by the record 1200. The record 1200 may further include a mapped RT field 1260. The mapped RT field 1260 includes one or more RTs used to link an ad to the ad space represented by the record 1200.

Turning back to FIG. 10, the adcaster 1000 may also include a configuration agent 1050 coupled to the publisher inventory 1040 and to the subscriber RT database 1026. The configuration agent 1050 receives configuration information associated with the adcaster 1000 from an adcaster configuration module 1054 in a controlling IABA. The configuration agent 1050 downloads subscriber RT records (e.g., the example set of subscriber RT records 1100) from the IABA to the subscriber RT database 1026. The configuration agent 1050 also downloads publisher inventory records (e.g., the example publisher inventory record 1200) from the IABA to the publisher inventory database 1040.

The adcaster 1000 may further include a monitoring agent 1060 communicatively coupled to the communication server 1010. The monitoring agent 1060 gathers status and performance information associated with the adcaster 1000 and reports the status and performance information to a monitoring module 1064 associated with a controlling IABA. The status information may include real-time operational checks such as memory, disk space, and CPU utilization, among others. Performance tracking may include real-time access to ad flow rates (e.g., a number of ads flowing per second as sourced by the adcaster 1000 or by a third-party ad provider), a number of user sessions online at a specified point in time, and a number or rate of accepted and rejected ad bids, among others.

### Internet Advertising Brokerage Apparatus Architecture

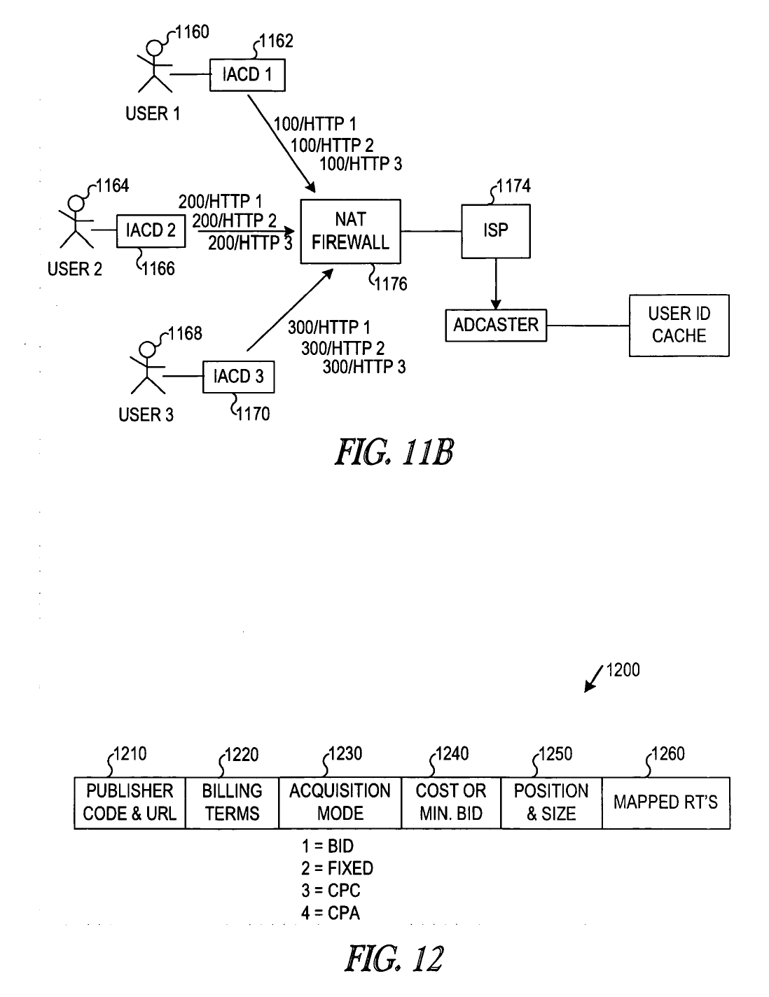

FIG. 13 is a block diagram of an internet advertising brokerage apparatus (IABA) 1300 according to various example embodiments. The IABA 1300 maintains a publisher inventory database 1310, an ad inventory database 1316, a group subscriber RT database 1320, and/or an ad performance statistics database 1322. The IABA 1300 analyzes ad placement opportunity requests 1323 presented to it by an ad placement request node 1324. An ad placement opportunity in this context is a representation, often expressed as an HTTP request, of a portion of a recently-displayed browser page reserved for an ad insertion. The ad placement opportunity may also comprise a representation of a portion of a browser page whose display is imminent. The browser page typically contains content requested by a subscriber and delivered by a content publisher. The ad placement request node 1324 may include adcasters, content publishers, advertisers, and ad brokers, without limitation.

The IABA 1300 returns ad placement recommendations 1325 to the ad placement request node 1324 in response to the ad placement opportunity request 1323. The ad placement recommendations 1325 may include a request flag indicating that the IABA 1300 wishes to be considered as an ad provider. The ad placement recommendations 1325 may also include a purchase bid representing an offer to purchase ad space for a specified consideration (e.g., a specified amount of money). The ad placement recommendations 1325 may further include a recommended ad delivery method.

The IABA 1300 may also respond to ad requests, including ad requests redirected to the IABA 1300. The IABA 1300 may respond to ad requests by supplying appropriate ad content directly, by pointing the ad requester to appropriate ad content hosted elsewhere, or by providing targeting RTs to assist the requesting entity in finding an appropriately-targeted ad. The IABA 1300 may pull directly-supplied ad content from one or more ad servers 1340 hosted by the IABA 1300 or may feed ad content from an external ad-feed server 1344. In the latter case the feed may optionally be delivered to the IABA 1300 via an ad feed API 1348.

The IABA 1300 may collect and distribute ad performance statistics associated with ad placement attempts, including placement revenues, costs, and other statistics as further described below. The IABA 1300 may also act as a controller for a plurality of adcasters in an advertising network. In its capacity as a controller, the IABA 1300 downloads database and configuration information to the adcasters and performs adcaster monitoring operations.

A target server 1326 associated with the IABA 1300 may receive ad opportunity requests 1323 from one or more ad placement request nodes 1324 on the Internet 108. The target server 1326 accesses one or more of the group subscriber RT database 1320, the publisher inventory database 1310, and the ad inventory database 1316, to obtain input data used to analyze an ad placement opportunity associated with the request 1323. The target server 1326 subsequently formulates an ad placement recommendation response 1325 and transmits the response 1325 to the ad placement request node 1324 or to some other entity. In some example embodiments the ad placement recommendation 1325 may comprise one or more enhanced RTs. The afore-mentioned ad placement analysis and recommendation method is explained in greater detail further below.

Turning back to FIG. 11, the record format of the group subscriber RT database 1320 is similar or identical to the example set of RT records 1100 of the subscriber RT database 1026. Notably, one or more enhanced, scored RTs (e.g., the RTs 1179 of the example set of RT records 1100) may be associated by the group subscriber RT database 1320 with a UID in an incoming ad placement opportunity request 1323. The score may comprise a propensity value associated with the propensity field 1146 calculated as previously described.

The target server 1326 may retrieve enhanced RTs from the group subscriber RT database 1320 as previously mentioned. The group subscriber RT database 1320 may be populated asynchronously relative to ad placement operations as follows. A relevancy server 1327 may receive RTs from a variety of sources including adcasters. Adcasters may collect the RTs from vectored browsing streams, from ISP-based subscriber information databases, and from knowledge of subscriber connectivity, geography, and demographics, among other sources. The relevancy server 1327 may also received RTs from a third-party RT supplier 1328 such as an internet site ratings company.

The relevancy server 1327 passes the received RTs to a group relevancy AI module 1329. The group relevancy AI module 1329 may generate additional RTs from the received RTs by analyzing search strings, search habits, internet access methods, and location-based demographics.

For example, suppose that a set of RTs received by the relevancy server 1327 for a particular subscriber includes the RT “zipcode=91010” as in the second record of the example set of RT records 1100 of FIG. 11. The group relevancy module 1329 may have access to information from publicly available sources such as census data. The group relevancy module 1329 may perform association operations on the RT “zipcode=91010” such as integrating the public census data to determine that the average household from zip code 91010 includes two pets. The AI module 1329 may then add an “enhanced” RT record of “two pets” 1180 to the group subscriber database 1320 for the particular subscriber.

The group relevancy AI module 1329 may also perform ontology-based RT synthesis operations associated with individual subscribers or groups of subscribers. The group relevancy AI module 1329 performs searches of an ontology database 1332 for one or more keyword RTs and/or key phrase RTs and adds keywords from the returned results as additional keyword RTs to the group subscriber RT database 1320. This process is described in detail further below.

The target server 1326 may search the group subscriber RT database 1320 for RTs associated with the incoming ad placement opportunity request 1323. RTs may be selected from the group subscriber RT database 1320 based upon a strength of association metric value relating the RTs from the database 1320 to the RTs from the incoming ad placement opportunity request 1323. Factors used in calculating the strength of association metric value may include the propensity value associated with the propensity field 1146 and a pattern match between the RTs from the database 1320 and the RTs from the incoming ad placement opportunity request 1323, among other factors. The selected RTs are accumulated with RTs from the incoming ad placement opportunity request 1323 in a targeting RT buffer 1336 associated with the target server 1326.

Additional RTs may be accumulated by the target server 1326 into the targeting RT buffer 1336 from the publisher inventory database 1310. The record format of the publisher inventory database 1310 is similar to that of the publisher inventory database 1040 associated with the adcaster 1000. Turning back to FIG. 12, from the example record 1200 it can be seen that each record in the publisher inventory databases 1040 and 1310 relates one or more mapped RTs 1260 to a publisher 1210. The publisher code 1210, received with the incoming ad placement opportunity request 1323, may be used to index the mapped RTs 1260 from the publisher inventory database 1310 for accumulation in the targeting RT buffer 1336.

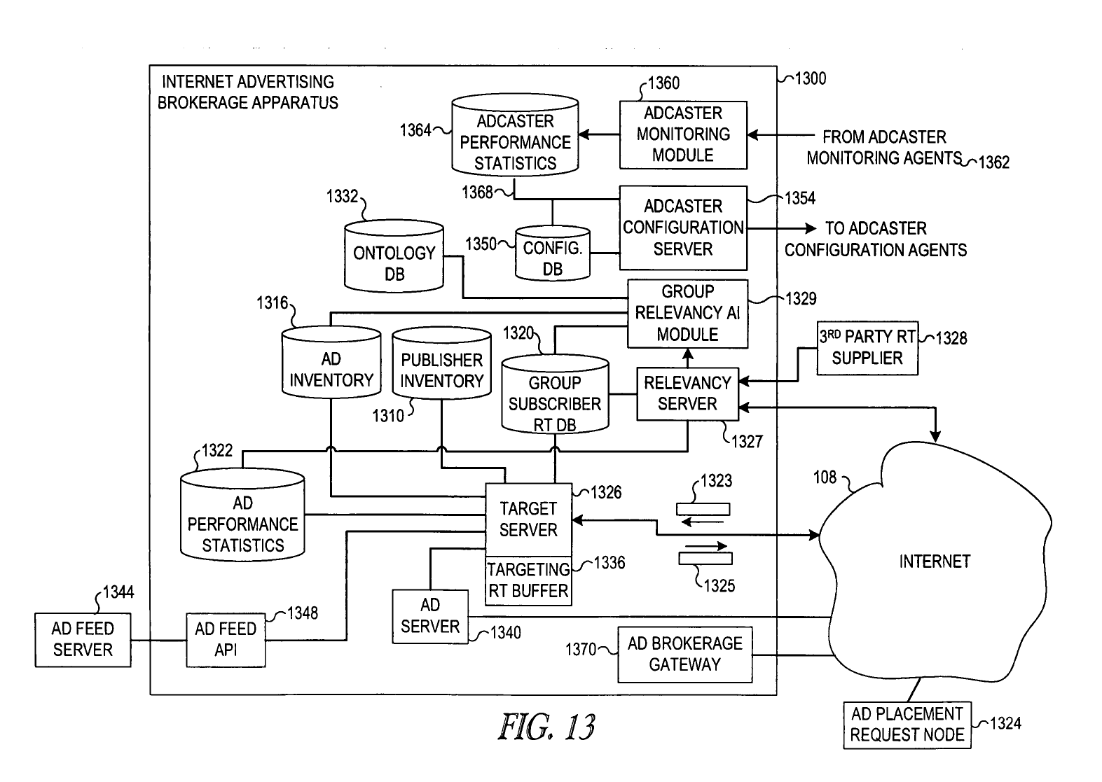

FIG. 14 is a field layout diagram of a record 1400 associated with the ad inventory database 1316 according to various example embodiments. The example record 1400 comprises an ad code field 1410, a sale dollar amount field 1412, a billing terms field 1414, a purchase mode flag 1418, a basis flag 1424, a delivery method flag 1430, an ad run period field 1436, an RT requirements field 1440, and an ad content address field 1444.

Having accumulated RTs from the afore-described resources in the targeting RT buffer 1336, the target server 1326 may then pattern-match the RTs from the RT buffer 1336 against RTs associated with records in the ad inventory database 1316. Matching operations may be based upon a variety of pattern matching methods and heuristics designed to extract the ad from the ad inventory database 1316 that is best-targeted to the subscriber whose browsing initiated the ad placement opportunity request 1323. If the matching operations find a subset of two or more ads that are equally well-targeted, some example embodiments may choose the ad from subset that will generate the highest revenue according to the sale dollar amount field 1412. If the sale dollar amounts are equal for two or more ads selected from the subset, the latter ads may be selected using a round-robin approach for subsequent requests.

Having selected the best-targeted ad for the currently-browsing subscriber, the target server 1326 may decide whether or not to set an “interest request” flag in the ad placement recommendations response 1325 indicating that the IABA 1300 wishes to be considered by an ad requester as a participant in the ad delivery process. “Ad requester” in this context means a content provider or ad broker in a position relative to an imminent internet ad placement opportunity to involve a third party in delivering ad content associated with the ad placement opportunity. The term “content provider” may be used in subsequent examples to mean “ad requester” without loss of generality.

If the target server 1326 does set the interest request flag, the target server 1326 may also include an ad space purchase bid in the ad placement recommendations 1325. The target server may further include the delivery method specified in the delivery method field 1430 of the ad record selected from the ad inventory database 1316. The interest, bid amount, and delivery method information from the ad placement recommendations 1325 may enable the originating content provider to decide whether to involve the IABA 1300 in the ad delivery process by redirecting an ad request from the subscriber to the IABA 1300.

If the originating content provider redirects the ad request from the subscriber to the IABA 1300, the IABA 1300 may respond to the ad request by supplying appropriate ad content directly from the ad servers 1340 or the ad feed server 1344, by pointing the ad requester to appropriate ad content hosted elsewhere, or by providing targeting RTs to assist the requesting entity in finding an appropriately-targeted ad. The IABA 1300 may pull directly-supplied ad content from one or more ad servers 1340 hosted by the IABA 1300 or may feed ad content from an external ad-feed server 1344.

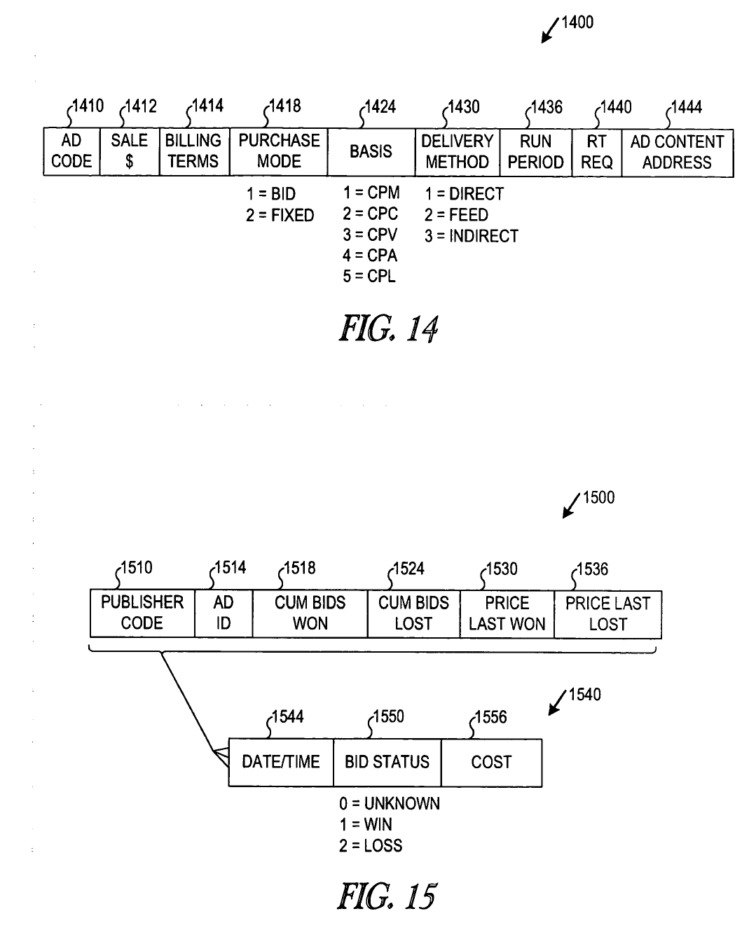

FIG. 15 is a field layout diagram of a record 1500 associated with an ad performance statistics database 1322 according to various example embodiments. The example record 1500 includes a publisher code field 1510, an ad ID field 1514, a cumulative count of bids won 1518, a cumulative count of bids lost 1524, a price last won field 1530 and a price last lost field 1536. The price last won field 1530 and the price last lost field 1536 both contain the winning and losing bids associated with the last-observed winning and losing transactions, respectively. The example record 1500 contains cumulative ad placement statistics associated with ad placement offers issued by the IABA 1300 to a particular publisher on behalf of a particular subscriber.

In an example embodiment, transaction statistic detail records 1540 are created within the ad performance statistics database 1322 in a one-to-many relationship with the example record 1500. Each of the transaction statistic detail records 1540 includes a date and time field 1544, a bid status code field 1550, and a cost field 1556, all associated with the bid attempt. The bid status code field 1550 indicates a win or loss associated with the bid attempt. The cost field 1556 indicates the winning bid price.

Example embodiments herein may use statistics accumulated in the ad performance statistics database 1322 over multiple transactions to increase profitability. Profitability may be increased by bidding low enough to assure a desirable number of wins and bidding high enough to assure a desirable profit margin.

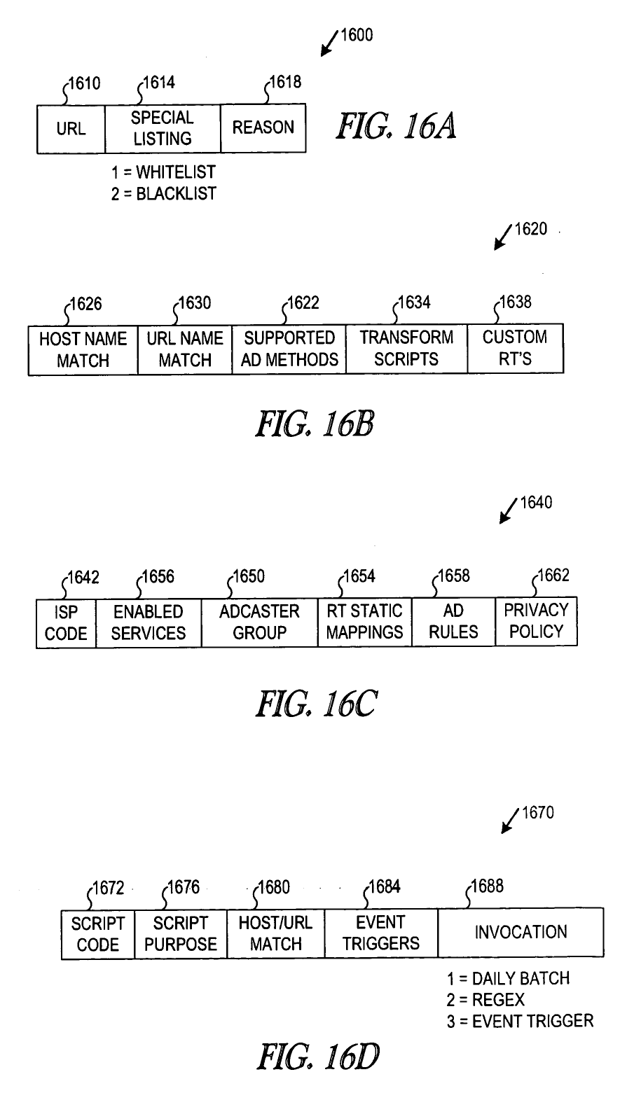

FIGS. 16A-16D are field layout diagrams of example records associated with a configuration server database 1350 according to various example embodiments. An adcaster configuration server 1354 accesses the configuration server database 1350 in order to configure one or more adcasters in an adcaster network controlled by the IABA 1300.

Records 1600 illustrated in FIG. 16A associate certain identified URLs 1610 with special listings 1614 for reasons given in field 1618. The records 1600 are identified by the IABA 1300 and are sent to one or more adcasters from time to time. The adcasters may use identified URLs 1610 to flag desirable and undesirable HTTP transactions. White-listed URLs may enhance ad services operations associated with an adcaster. Blacklisted URLs are known or suspected as undesirable and may be excluded by the adcaster from ad placement operations.

The IABA 1300 may, perhaps with the assistance of quality assurance (QA) personnel, view a URL associated with a particular web page or ad publisher and check website information addressed using the URL. The check may be made to ensure the safety of an in-stream modification. The approved white list may be used to approve the ad-insertion service by signaling to the adcaster that it is ok place additional ad content into a request.

Taking an example of a “blacklisted” URL, the system may receive an ad placement opportunity request that results from subscriber browsing at a particular publisher URL. The IABA 1300 may check the identified URL records 1600 for the publisher URL before deciding to bid on the ad placement opportunity. If the IABA 1300 or the adcaster finds the publisher URL in the blacklist, the adcaster may be signaled to avoid any modification to the internet stream associated with the blacklisted URL.

A URL may be blacklisted as a result of the IABA 1300 having flagged the URL as associated with a supplier of pornographic or other undesirable content. Policies associated with the IABA 1300 may be established to exclude this form of advertising. A blacklisted entry may also be made in a record 1600 as a result of a content owner's decision to opt out of services provided by the IABA 1300.

An ad placement opportunity record 1620 as illustrated in FIG. 16B may be used to signal an adcaster to apply one of a list of supported ad methods 1622 while observing a browsing stream. The supported ad methods 1622 refers to a list of supported methods invoked by an adcaster when matching occurs.

The methods 1622 may match some part or all of a host name 1626 (e.g., “XYZ.com) or a URL 1630 (e.g., “XYZ.com/business.htm”). The format of the ad placement opportunity record 1620 is just an example of a two-part match. Other example embodiments may perform n-part matches, matches on types of ISP services (e.g., business or residential), matches on subscriber profile information, on information derived by an ISP, on other parts of the internet browsing stream or on data encapsulated within transmitted protocols.

In some example embodiments the two-part match is used to differentiate between a direct opportunity and indirect opportunity. Both the host name 1626 and the URL name 1630 are matched in the case of a direct opportunity. Only the host name 1626 is matched in the case of an indirect opportunity. Various matching algorithms may be employed including regular expression matching or matching using a customized script and/or specially built software.

Some example embodiments may choose matching approaches to correspond to various ad placement topologies and requirements. Taking an indirect case as an example, a publisher network may acquire rights to deliver ads to a number of web pages associated with a plurality of websites. An adcaster in this situation may provide ad placement services to some or all internet stream data to and/or from the publisher inventory associated with the publisher network.

In contrast, matching may be more specific in a direct placement environment and may include any part of a web site, a web page, an ad server depositing ad content onto a web page, and/or an ad network or ad feed placing content on a page. The matching may also be used to identify sections or spots of pages such that specific areas of content and relevancy information about the context can be used to match interests to invoke ad placement operations.

A code transform field 1634 may point to program code, to an application residing on the adcaster, to a script that may interact with any system components, applications, or data. The code may be raw or compiled and may reference other system components such as a pre-defined data mining script pointed to by the frame 1670 illustrated in FIG. 16D. The code referred to by the code transform field may perform various classes of work including further evaluating a match, performing RT analysis, or updating other component of the system. The code may also produce custom relevancy tags that may be unavailable except during real-time analysis. A custom RT field 1638 may refer to a list of predefined RTs corresponding to an ad placement opportunity pattern match.

A customer configuration record 1640 as illustrated in FIG. 16C may enable methods of central adcaster management. For example, the customer configuration record 1640 may provide configuration information to groups of adcasters at multiple locations, perhaps serving various classes of ISP services including dialup, broadband, and wireless.

An ISP code field 1642 may be used by an IABA to organize adcasters deployed in a particular ISP network. The code may be used for monitoring, provisioning of ad services, and billing, among other uses.

Each adcaster has a unique identifier similar to an equipment serial number. An adcaster identifier may be recorded as being associated with a customer configuration. An adcaster group field 1650 refers to a group of related adcasters. The adcasters may be listed together such that the group operates according to a common suite of configurations within a customer profile. Members of a group of adcasters identified by the adcaster group field 1650 may be located at a point of presence (POP) associated with an ISP, at the ISP's network operations center (NOC), at a data center, or at an upstream provider location, as previously explained.

As a result of the diversity of ISP customer types and locations it may be possible to define RTs according to type of ISP, types of services enabled, and/or ad caster location. An RT static mappings field 1654 may indicate these RTs. A wireless ISP may, for example, have multiple adcasters installed in geographically disburse areas. A “wireless” RT may be defined for the ISP and may correspond to all adcasters in the wireless ISP network. Additional sets of RTs may be defined by geographical areas, including perhaps city, town, and zip code RT designations.

The RT mappings may alternatively be produced dynamically. Dynamic RT mappings may include location tags derived from service provider geographic mappings, traditional authentication attribute value pairs from AAA servers (e.g., RADIUS), and additional attribute values tied to the RADIUS user account profile by the service provider. With dial-up access, AAA attribute value pairs may also include NPA/NXX from the calling station and the called station. These attributes may help to further associate users to geographic RT values based upon the current dialing location as well as the destination location to which the user is dialing.

The customer configuration record 1640 may also include an enabled services field 1656, an ad rules field 1658, a user privacy policy field 1662, and others related to adcaster configuration. A configuration may include fields containing source code, references to applications, or other interpreted code usable to perform a variety of customized data mining operations capable of producing specialized RTs. The afore-mentioned configurations are merely examples. Other configuration fields may be associated with the configuration server database 1350 according to various example embodiments.

The data mining script pointer record 1670 may include a script code field 1672, a script purpose field 1676, a host match/URL match field 1680, an event triggers field 1684, and/or an invocation field 1688.

Turning back to FIG. 13, the IABA 1300 may also include an adcaster monitoring module 1360. The adcaster monitoring module 1360 may be communicatively coupled to monitoring agents 1362 (e.g., the monitoring agent 1060 of FIG. 10) associated with one or more adcasters. The adcaster monitoring module 1360 may receive real-time operational statistics from the adcasters, including but not limited to memory, disk space, and CPU utilization, ad flow rates, a number of user sessions online at a specified point in time, and a number or rate of accepted and rejected ad bids, as previously described. The statistics may be written to an adcaster performance statistics database 1364. Alternatively, or in addition, the adcaster statistics may be accumulated by the adcaster monitoring module 1360 and the accumulated statistics may be stored in the adcaster performance statistics database 1364 at a later time.

The adcaster performance statistics database 1364 may be coupled to the adcaster configuration server 1354 via a feedback coupling 1368. The adcaster configuration server 1354 may access adcaster statistics from the adcaster performance statistics database 1364 for the purpose of adjusting adcaster configurations to enhance performance.

An ad brokerage gateway 1370 may be coupled to the publisher inventory database 1310, to the ad inventory database 1316, to the group subscriber RT database 1320, to the ad performance statistics database 1322, to the adcaster configuration database 1350, and/or to the adcaster performance statistics database 1364. The ad brokerage gateway 1370 may comprise a public portal through which authorized personnel may access the various databases and configuration mechanisms associated with the IABA 1300. Some example embodiments may grant read and/or write access to the IABA 1300 for various purposes including viewing performance statistics and downloading or uploading RTs, ad content, ad inventory records, publisher inventory records, and configuration parameters.

### Relevancy Information Flow and Methods

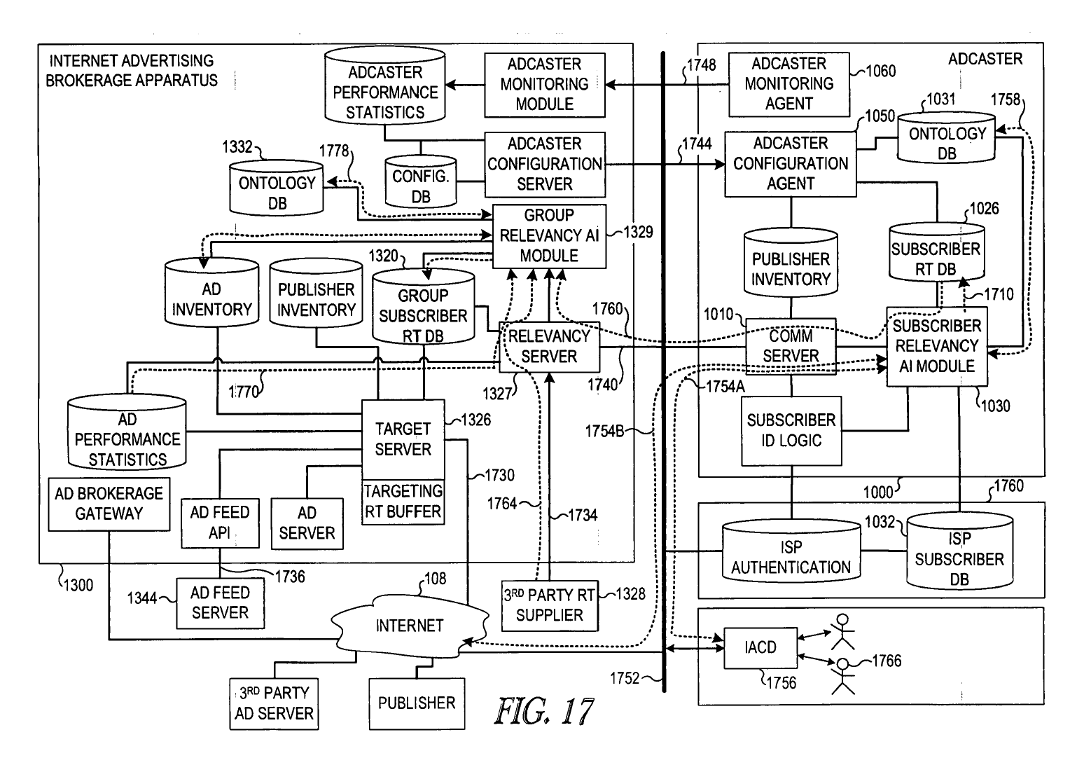

FIG. 17 is a functional block diagram illustrating relevancy information flow according to various example embodiments. Connections to and/or from an IABA 1300 include a connection 1730 from a target server 1326, a connection 1734 to a third-party RT supplier 1328, a connection 1736 to an ad feed sever 1344, a connection 1740 to an adcaster communications server 1010, a connection 1744 to an adcaster configuration agent 1050, and a connection 1748 to an adcaster monitoring agent 1060. It is noted that any of these connections may be made via an Internet 108, a non-internet communications link such as a T1 link, an optical fiber link, other terrestrial or satellite link, and/or a remote or interprocess communications link such as an API. Thus, some links are illustrated on FIG. 17 as direct links merely for the sake of clarity as to function. Such links may in fact traverse the various types of paths as previously described. The network 1752 is associated with an ISP 1760.

The subscriber relevancy AI module 1030 associated with the adcaster 1000 may accumulate relevancy information and generate RTs from relevancy information harvested from subscriber data streams 1754A and 1754B, from the ISP subscriber database 1032, from internet connection provisioning information associated with a subscriber IACD 1756, and/or from any other relevancy information discernible by the subscriber relevancy AI module 1030, as previously described.

The subscriber relevancy AI module 1030 may also perform keyword searches of one or more keyword or key phrase RTs against an ontology database 1031 via a path 1758. The search results may yield URLs with associated keywords. The keywords may be used as additional, synthesized keyword RTs as described further below. The subscriber relevancy AI module 1030 may store the generated and synthesized RTs in a subscriber RT database 1026 via a path 1710.

RTs from the subscriber RT database 1026 may, from time-to-time or periodically, be transferred to the relevancy server 1327 at the IABA 1300 via a path 1760. The transferred RTs may comprise search strings, search habits, internet access methods, and location-based demographics associated with a subscriber 1766. Additional RTs may be transferred to the group relevancy AI module 1329 via the relevancy server 1327 from a third-party RT supplier 1328 along a path 1764. The relevancy server 1327 may also access the publisher inventory database 1310 to accumulate additional RTs.

The relevancy server 1327 may pass the various accumulated RTs to a group relevancy AI module 1329. The group relevancy AI module 1329 processes the RTs to generate additional RTs from the accumulated RTs. The relevancy AI module 1329 analyzes the search strings, search habits, internet access methods, and location-based demographics associated with the subscriber 1766 and performs “casting” operations to generate the additional RTs.

Casting operations utilized by example embodiments herein exploit known or suspected semantic and other associative links between keywords, behaviors, locations, entities, and topics to inductively expand a set of RTs into a larger set. Casting operations may include search casting, channel casting, competitive casting, geo-casting, behavioral casting, and DMA-casting, among others. Search casting is a method of expanding a set of keywords using ontology-based RT synthesis operations and is explained in detail below.

Channel casting is an inductive method of generating RTs from known relationships between marketing channels. For example, for a subscriber browsing websites related to hockey and also browsing a sporting goods website, some example embodiments may assign RTs related to hockey equipment and/or clothing from a manufacturer with distribution through the sporting goods website.

Competitive casting may result in the assignment of RTs associated with entities that are competitive to a browsed entity. For example, if a subscriber browses to information pertaining to a luxury automobile manufactured by Company A, example embodiments herein may generate RTs associated with luxury automobile models manufactured by Company B.

Geo-casting is a method of sensing a subscriber's geographical location and generating associated RTs. Some example embodiments may generate RTs based upon an inductively-determined socio-economic level associated with a subscriber's connection to the Internet. The geo-casted RTs may be used as factors in determining price points of goods and services presented to the subscriber. For example, example embodiments herein may present luxury automobile ads to a subscriber browsing pages containing automotive content if internet connection provisioning information indicates that the subscriber resides in an upscale neighborhood.

DMA-casting is the inference linking of offline data such as Prism Collectors, or any such offline data, to enhance the subscriber profile with new RTs representing segmentation of digital marking groups. These RTs may include the number of children in a household, gender of family members, income level, credit scoring, or any other information used by direct marketing groups.

Some example embodiments may use behavioral casting methods to track a subscriber's browsing habits and to generate RTs with a high correlation to the browsing habits. For example, an RT may be generated to indicate interest in a digital camera if a subscriber browses to one or more articles associated with digital photography and browses to camera-for-sale pages associated with one or more online retailers of digital cameras.

The group relevancy AI module 1329 may use ontology-based keyword RT synthesis methods to perform search casting operations. Keyword RT synthesis may apply to individual subscribers or to groups of subscribers. The group relevancy AI module 1329 accesses an ontology database 1332 via a path 1778 to perform searches using one or more keyword RTs and/or key phrase RTs. The group relevancy AI module 1329 then adds keywords from the returned results as additional keyword RTs to the group subscriber RT database 1320. This process is described in detail further below. The accumulated RTs and the AI-generated RTs may be stored in the group subscriber RT database 1320 for use in enhancing ad placement opportunities as previously described.

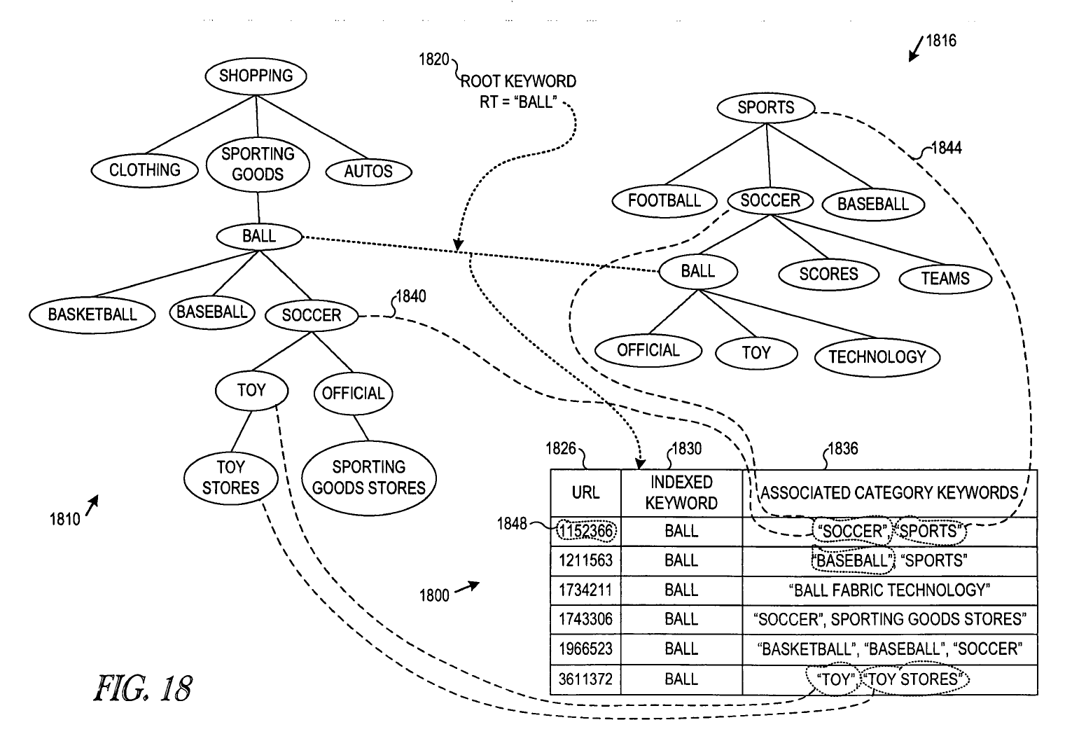

FIG. 18 is an ontology database search results table 1800 and associated ontology hierarchies 1810 and 1816 used in RT synthesis according to various example embodiments. These examples illustrate how category keywords associated with URLs returned from a search map into ontology hierarchies corresponding to the ontology database 1332.

The ontology database 1332 organizes keywords associated with human knowledge found in pages located at URLs stored in the ontology database 1332. The keywords are organized in an ontological tree such that each keyword is hierarchically “nearby” other subject matter-related keywords. Various ontology databases and structures may be used, including an Open Directory Project (ODP) hierarchically-organized URL database denoted “DMOZ” (acronym derived from directory.mozilla.org), among others. Additional information regarding the DMOZ directory may be found at the Open Directory Project website at http://www.dmoz.org.

Example embodiments herein may perform a search of the ontology database for an existing keyword RT, keyphrase RT, or a Boolean combination of existing RTs. For example, a root keyword RT “ball” 1820 may be searched for in the ontology database 1031 or 1332. The search may return a set of URLs 1826 for the indexed keyword “ball” 1830. A record associated with each returned URL may contain one or more associated category keywords 1836. For example, the keywords “soccer” 1840 and “sports” 1844 may be associated with the URL 1848.

The various sets of associated category keywords 1836 effectively locate the root keyword RT “ball” 1820 within the example ontology hierarchies 1810 and 1816. The associated category keywords 1836 are ontologically “nearby” the root keyword RT “ball” 1820 in the ontology hierarchies 1810 and 1816. The associated category keywords 1836 are effectively related to the root keyword RT “ball” 1820 and may therefore be used by the subscriber relevancy AI module 1030 or by the group relevancy AI module 1329 as synthesized keyword RTs.

Turning back to FIG. 17, example embodiments herein may feed performance data from the ad performance statistics database 1322 back to the group relevancy AI module 1329 along a path 1770. The performance data feedback may be used by the group relevancy AI module 1329 to enhance trending operations associated with the accumulation of relevancy information, the generation of RTs from the accumulated relevancy information, and/or the synthesis of additional RTs from accumulated RTs.

The group relevancy AI module 1329 may also produce performance trends associated with user clicked advertising and/or popularly-clicked links on web pages representing user interest. The group relevancy AI module 1329 may accumulate a group of user statistics representing a broad view of these performance trends to provide additional weighting of parameters associated with the group relevancy AI module 1329.

The group AI module 1329 may incorporate third-party supplied software analytic techniques to provide additional performance trending that can be analyzed, modeled, and store into the subscriber profile. The AI module 1320 may use past performance trends to make predictions about future user behavior. Example embodiments may analyze feedback from past trends, group subscribers into AI trend categories, and then make predictions about subscriber behavior before the behavior is sensed in the HTTP datastream by an adcaster.

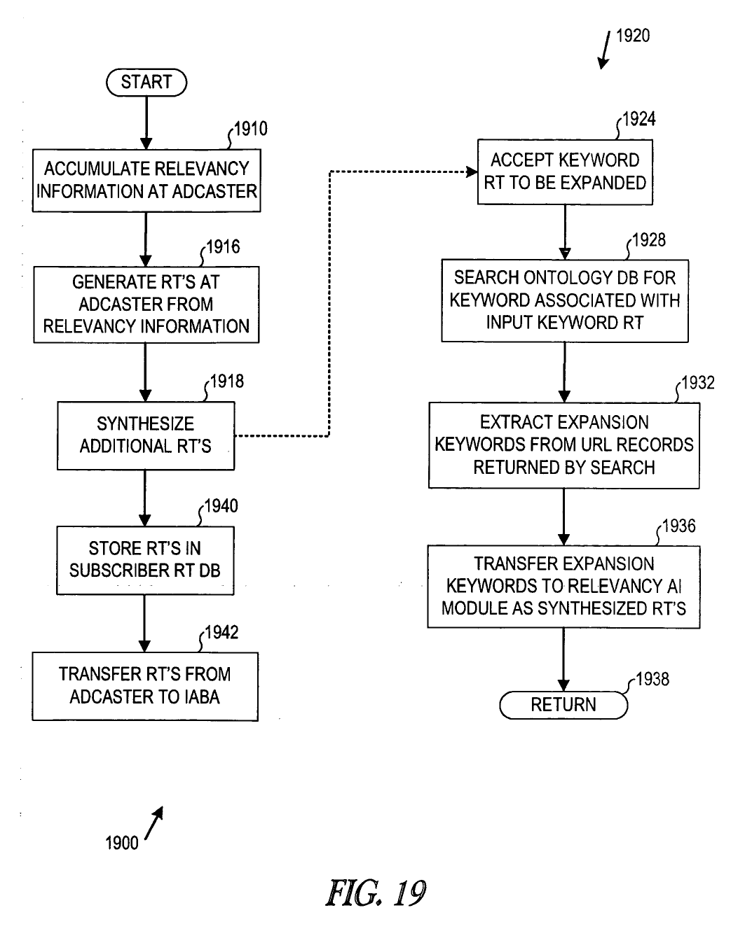

FIG. 19 is a flow diagram illustrating a method 1900 of relevancy tag enhancement at an adcaster according to an example embodiment. The method 1900 may commence at block 1910 with accumulating relevancy information at an adcaster. The relevancy information may be harvested from subscriber data streams, from an ISP subscriber database, from internet connection provisioning information, or from other sources as described herein.

The method 1900 may continue at block 1916 with generating one or more RTs at the adcaster from the accumulated relevancy information. The RTs may be formatted according to a pre-arranged format to provide for interoperability between the adcaster and an ad network. The method 1900 may optionally include expanding the set of accumulated RTs by synthesizing additional RTs, at block 1918. The synthesis of additional RTs is accomplished using a keyword RT synthesis routine 1920.

The keyword RT synthesis routine 1920 may commence at block 1924 with accepting a keyword RT to be expanded. The keyword RT synthesis routine 1920 may include searching an ontology database for an input keyword associated with the keyword RT to be expanded, at block 1928. The search may return one or more URL records indexed by the input keyword. Each such URL record may associate the input keyword to one or more expansion keywords. The keyword RT synthesis routine 1920 extracts the expansion keywords from the returned URL records, at block 1932. The keyword RT synthesis routine 1920 also transfers the expansion keywords to the requesting relevancy AI module, at block 1936. The keyword RT synthesis routine 1920 then returns control to the method 1900, at block 1938.

The method 1900 may continue at block 1940 with storing the generated and acquired RTs in a subscriber RT database. The method 1900 may include transferring a portion or all of the generated and acquired RTs to an IABA. Some example embodiments may transfer the RTs to a relevancy server in the IABA.

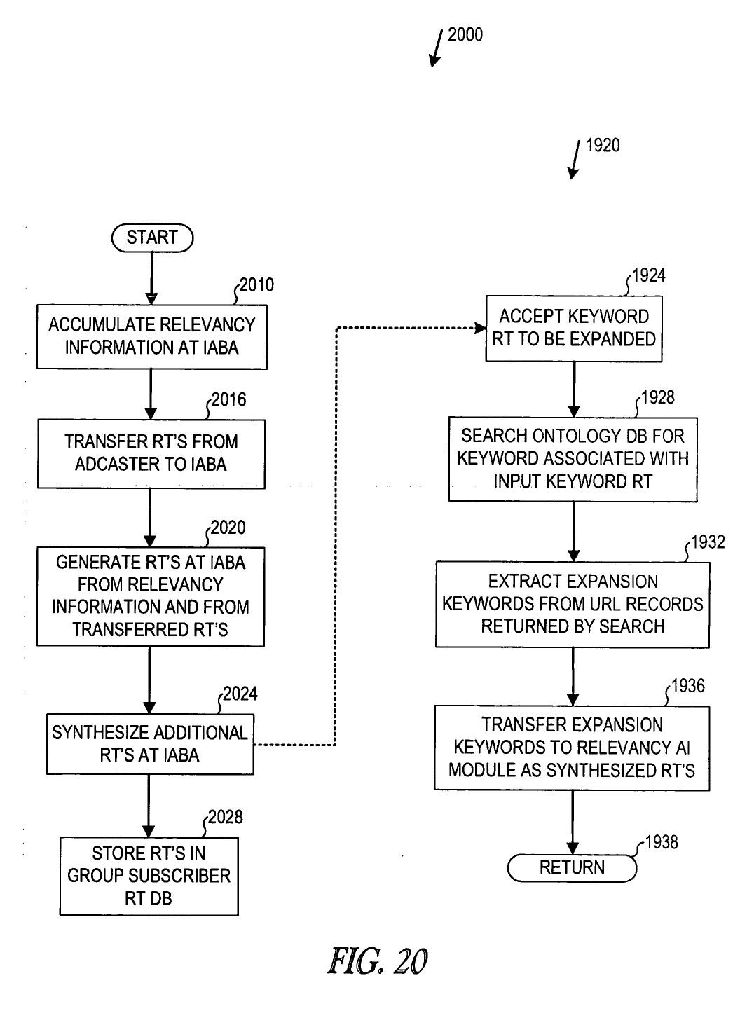

FIG. 20 is a flow diagram illustrating a method 2000 of relevancy tag enhancement at an IABA according to an example embodiment. The method 2000 may commence at block 2010 with accumulating relevancy information at an IABA. The relevancy information may be collected from a publisher inventory database, from an ad inventory database, and/or from a third-party RT supplier such as an internet ratings company, among other sources. The method 2000 may also include transferring RTs from an adcaster, at block 2016.

The method 2000 may continue at block 2020 with generating one or more RTs at the IABA from the accumulated relevancy information and/or from accumulated RTs. The RTs may be formatted according to a pre-arranged format to provide for interoperability between the adcaster and an ad network. The method 2000 may optionally include expanding the set of accumulated RTs by synthesizing additional RTs, at block 2024. The synthesis of additional RTs is accomplished using a keyword RT synthesis routine 1920, including the activities 1924, 1928, 1932, 1936, and 1938 as previously described. The method 2000 may also include storing the accumulated and synthesized RTs in a group subscriber database, at block 2028.

It is noted that some or all functionality associated with an IABA may be collapsed into or collocated with an adcaster in some system embodiments. In a network of adcasters, for example, group relevancy AI operations may be performed at a designated adcaster for member adcasters.

### Ad Brokering Transaction Flow and Methods

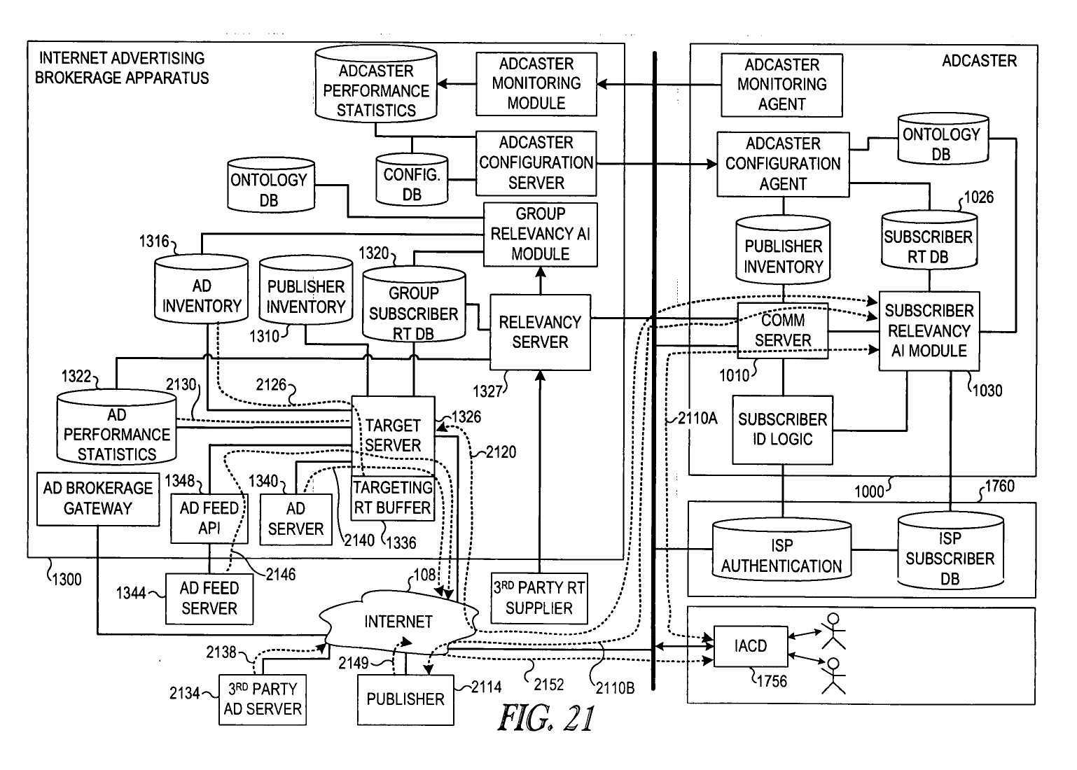

FIG. 21 is a functional block diagram illustrating example ad opportunity processing information flows according to various example embodiments. A target server 1326 associated with an IABA 1300 may receive an ad opportunity request originating from an adcaster 1000 via the Internet 108. The target server 1326 accesses one or more of a group subscriber RT database 1320, a publisher inventory database 1310, and an ad inventory database 1316 to obtain input data used to analyze an ad placement opportunity associated with the ad opportunity request. The target server 1326 subsequently formulates an ad placement recommendation response and transmits the response to the adcaster 1000 or to some other entity. In some example embodiments the ad placement recommendation may comprise one or more enhanced RTs.

A communications server 1010 associated with the adcaster 1000 redirects HTTP requests between an IACD 1756 and a content publisher 2114. The HTTP requests are redirected to a subscriber relevancy AI module 1030. During the course of one or more browsing sessions the subscriber relevancy AI module 1030 collects and enhances RTs and may synthesize new RTs using relevancy AI techniques as previously described. The collected, enhanced, and/or synthesized RTs are stored in a subscriber RT database 1026.

Upon sensing an ad request issued from the IACD 1756, the subscriber relevancy AI module 1030 appends relevant RTs from the subscriber RT database 1026 and redirects the ad request to a target server 1326 at the IABA 1300 along a path 2120. The target server 1326 associates additional RTs with the appended relevant RTs from the adcaster 1000 and stores a collective cache of RTs in a targeting RT buffer 1336. The target server 1326 acquires the additional RTs from a group subscriber RT database 1320 and from the publisher inventory database 1310, among other possible sources.

The target server 1326 then performs pattern matching operations between the cache of RTs stored in the targeting RT buffer 1336 and RTs associated with ad inventory records in the ad inventory database 1316 (e.g., RTs from the RT requirements field 1440 of the ad inventory record layout 1400 of FIG. 14) along a path 2126. If no suitable ad is found, the target server 1326 responds to the adcaster 1000 with a “decline” method type of 0 indicating that the system will not bid for the ad placement opportunity.

If a suitable ad is found in the ad inventory database 1316, the target server 1326 may choose between a number of possible ad delivery methods. Some example embodiments may consider factors such as profit margin when choosing the ad delivery method. For example, the target server 1326 may compare the potential revenue value of the ad placement (e.g., using the sale $ field 1412 of the ad inventory record layout 1400 of FIG. 14) with an estimate of the cost of the ad space.

The estimate of the cost of the ad space may be based upon historical data of winning bids. That is, the target server 1326 may access the ad performance statistics database 1322 across a path 2130 to retrieve the estimate (e.g., the last winning bid field 1530 and the last losing bid field 1536 of the ad performance statistics record 1500 of FIG. 15). Alternatively, if the ad space cost is fixed, the latter cost may be retrieved from the “cost/minimum bid” field 1240 of the appropriate ad space record in the publisher inventory database 1310. The appropriate ad space record is that record associated with the cached RTs stored in the targeting RT buffer 1336 by the “mapped RTs” field 1260. As a further alternative, the ad space cost may be retrieved from the content publisher. Example embodiments herein may use the comparison of the potential revenue to the estimated ad space cost to calculate the potential profit margin.

If the profit margin is above a selected threshold, the target server 1326 may respond to the content publisher 2114 via the adcaster 1000 by setting an interest request flag and indicating an ad delivery method of “bid.” The “bid” delivery method may be first-chosen because “bid” may enable other profit-increasing methods. If the content publisher 2114 chooses the IABA 1300 as the ad provider for the ad placement opportunity and the ad delivery method is “bid,” a third-party ad server 2134 may serve up the ad across a path 2138.

If the potential profit margin is below the selected threshold, the target server 1326 may choose an ad feed or an ad targeting delivery method. These examples of using profit margin as a factor in choosing the delivery method are not all-inclusive. Other factors to be considered may include the capability of the content publisher 2114 to accommodate the chosen ad delivery method.

If the content publisher 2114 chooses the IABA 1300 as the ad provider for the ad placement opportunity and the ad delivery method is “ad feed” the IABA 1300 may serve up the ad from one or more ad servers 1340 associated with the IABA 1300 via a path 2140. Alternatively the IABA 1300 may feed the ad from an external ad feed server 1344 via a path 2146. In the latter case, some example embodiments may employ an API 1348 to communicate between the ad feed server 1344 and the IABA 1300. The IABA 1300 may also retrieve the ad from the content publisher 2114 across a path 2149. In an example embodiment the IABA 1300 may modify an ad received from the content publisher according to RTs accessible by the IABA 1300. The chosen ad server may serve up the ad content via the Internet 108 across a path 2152.

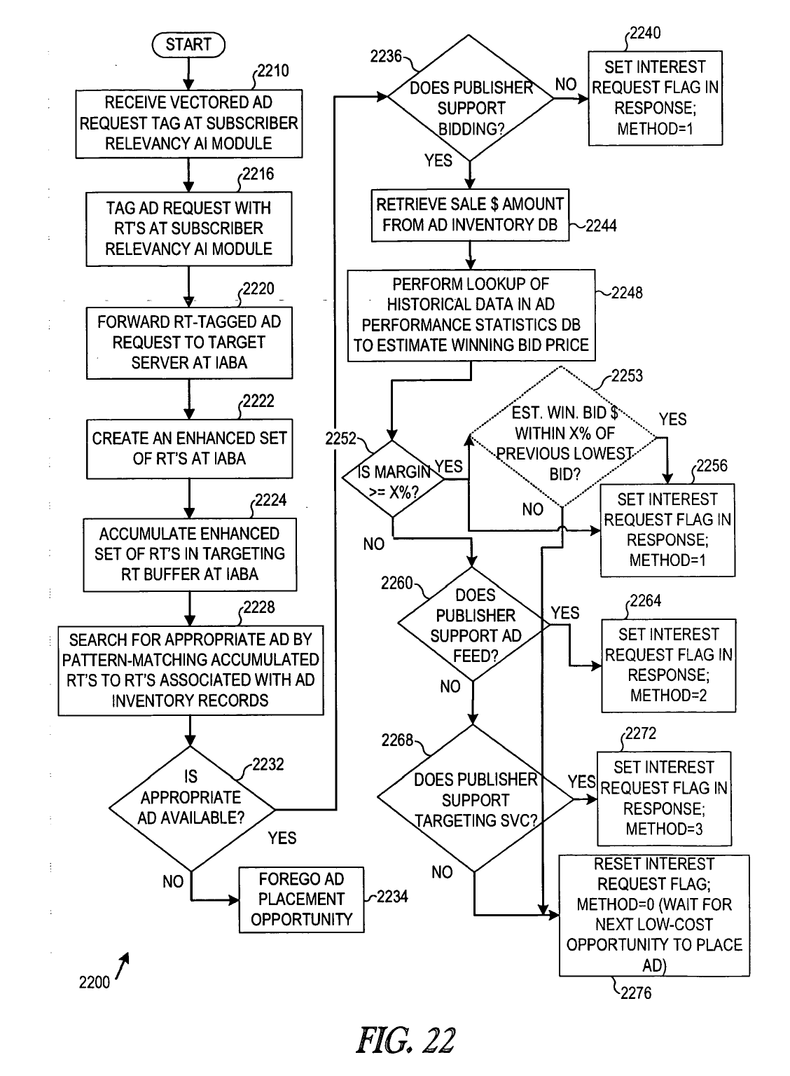

FIG. 22 is a flow diagram illustrating a method 2200 associated with an ad placement opportunity according to various example embodiments. The method 2200 may commence at block 2210 with receiving a vectored ad request tag at a subscriber relevancy module at an adcaster. The ad request tag may be vectored to the adcaster from an IACD using a variety of vectoring methods as previously described. The ad request tag may be sent by the IACD as a consequence of an ad tag transmitted to the IACD by a content provider as an ad placeholder element associated with a content page server up by the content provider.

The method 2200 may continue with tagging the outbound tag request with one or more RTs at the subscriber relevancy module, at block 2216. The method 2200 may include forwarding the RT-tagged ad request to a target server associated with an IABA, at block 2220. The method 2200 may also include enhancing the set of RTs received from the adcaster by associating additional RTs with the adcaster-supplied RTs, at block 2222. The additional RTs may derive from relevancy AI operations, from a publisher inventory database, and/or from a third-party RT supplier, as previously described. The set of adcaster-supplied RTs and the additional associated RTs may be accumulated in a targeting RT buffer at the IABA, at block 2224.

The method 2200 may continue at block 2228 with searching for a suitable ad by pattern-matching the RTs accumulated in the targeting RT buffer to a set of RTs associated with ad inventory records in an ad inventory database. The method 2200 may include determining whether an appropriate ad is found, at block 2232. If not, the method 2200 may include foregoing the ad placement opportunity, at block 2234.

If an appropriate ad is found, the method 2200 may continue at block 2236 with determining whether the content publisher or other ad provider supports bidding. If not, the method 2200 may include setting an interest request flag in the ad response to indicate an ad delivery method of “bid,” at block 2240.

If the publisher supports bidding, the method 2200 may include retrieving a sales revenue amount associated with the ad delivery opportunity from the ad inventory database, at block 2244. The method 2200 may also include performing a lookup of historical ad placement data in the ad performance statistics database to determine an estimate of a potentially winning bid price, at block 2248.

The method 2200 may also include calculating an estimated profit margin based upon the sales revenue amount associated with the selected ad and the estimated cost of the ad space and determining whether the resulting estimated profit margin is above a selected percentage, at block 2252. If the estimated profit margin is above the selected percentage, the method 2200 may continue at block 2256 with setting the interest request flag in the response and in indicating an ad delivery method=1, corresponding to the “bid” ad feed method.

Alternatively, if the estimated profit margin is above the selected percentage, the method 2200 may optionally continue at block 2253 with determining whether the estimated winning bid price for the ad space is within a selected percentage of the previous lowest bid price. If so, the method 2200 may continue at block 2256 as previously described. If the estimated winning bid price for the ad space is not within the selected percentage of the previous lowest bid price, the method 2200 may continue at block 2276 with resetting the interest request flag, indicating method 0 corresponding to no current response (e.g., waiting for a subsequent ad placement opportunity to place a pending ad).

Example embodiments may also wait for a subsequent ad placement opportunity if signaled to do so in response to a query to the AI module 1329. The AI module 1329 may store special-purpose RTs used to predict if, when, and/or under what circumstances a subscriber is likely to click on an ad being considered for placement. The RTs may be derived from predictive feedback methods including whether the subscriber has been observed previously clicking on a particular type of advertising. Such RTs may also be derived from knowledge that the subscriber is a member of a similar AI group who may click on particular ads at a particular time or under particular circumstances. Past behavioral trends may be combined with future behavioral predictions for these purposes.

If the estimated profit margin is not greater than the selected percentage, the method 2200 may include determining whether the publisher supports ad feed methods, at block 2260. If the content publisher does support ad feed methods, the method 2200 may include setting the interest request flag in the response and indicating an ad feed method=2, corresponding to the “feed” ad delivery method, at block 2264.

If the content publisher does not support ad feed methods, the method 2200 may continue at block 2268 with determining whether the publisher supports ad targeting services. If so, the method 2200 may include setting the interest request flag in the response and indicating an ad delivery method=3, corresponding to the “ad targeting” delivery method, at block 2272. If the content publisher does not support ad targeting, the method 2200 may include resetting the interest request flag and indicating an ad delivery method=0 (e.g., waiting for a subsequent ad placement opportunity to place a pending ad), at block 2276. The ad delivery method of zero indicates that the IABA will not be involved with the ad placement opportunity.

FIG. 22A is an RT matching diagram showing ad campaign-based ad selection according to various example embodiments. Each one of a set of ad campaign records 2274 may represent an ad campaign. In some embodiments the ad campaign records 2274 may be stored in the ad inventory database 1316 of FIG. 21. In some embodiments these records may be stored in an ad campaign database.

An ad campaign advertiser may select a set of RTs representing customers or potential customers to be targeted by the ad campaign. For example, the RTs GEO=91010-92010 and AI=“CARS” are associated with the example ad campaign record 2276. In another example, the RTs EXTERNAL=“JOGGING” and AI=“HEALTH”, “FITNESS” are associated with the example “Healthy Choice” ad campaign represented by the ad campaign record 2278. It is noted that an RT of the type “EXTERNAL” may derive from a source of RTs external to the IABA 1300. It is further noted that externally-generated RTs may be linked (e.g., in Boolean combinations) with RTs generated by an adcaster 1000 and/or by the IABA 1300.

As ad placement opportunities are received at the IABA 1300, RTs accumulated in the targeting RT buffer 1336 (e.g., the RTs associated with the session records 2280) are matched against the RTs associated with the ad campaign records 2274. A propensity metric value may be associated with each of the accumulated RTs as previously described for the RT database record of FIG. 11. Example embodiments herein may choose the ad corresponding to the ad campaign with the highest quality match between the accumulated RTs and the RTs associated with all ad campaigns as measured by the propensity metric value (e.g., the example match 2284 resulting in the selection of the ad corresponding to the example “Healthy Choice” ad campaign).

### Ad Brokering Transaction Flow and Methods

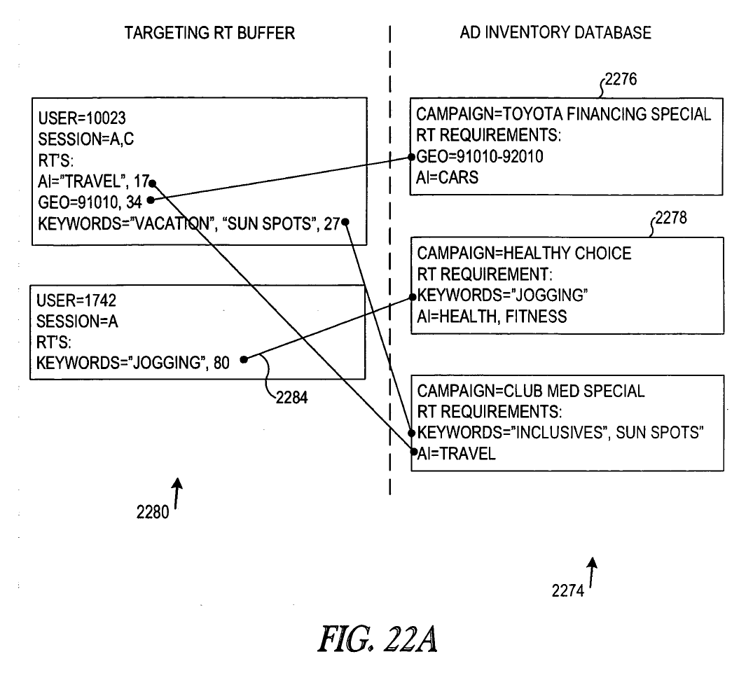

FIG. 23 is a functional block diagram illustrating adcaster configuration and monitoring information flow according to various example embodiments. An adcaster configuration server 1354 accesses a configuration server database 1350 to retrieve configuration information associated with one or more adcasters (e.g., the adcaster 1000). The adcasters may operate in an adcaster network controlled by the IABA 1300. The adcaster configuration server 1354 may communicate with an adcaster configuration agent 1050 associated with the adcaster 1000 via a communication path 1744. The communication path 1744 may comprise a path traversing the Internet. The configuration information may include operational parameters such as those previously described in conjunction with the record layout diagrams 16A, 16B, 16C, and 16D.

The adcaster configuration server 1354 may populate an adcaster publisher inventory database 1040 via a path 2310. The adcaster configuration server 1354 may replicate some portions or all of a publisher inventory database 1310 associated with the IABA 1300 in order to populate the adcaster publisher inventory database 1040. The adcaster configuration server 1354 may also populate an adcaster subscriber RT database 1026 via a path 2316 by replicating some portions or all of a group subscriber RT database 1320 associated with the IABA 1300. The adcaster configuration server 1354 may also populate an adcaster ontology database 1031 via a path 2322 by replicating some portions or all of an ontology database 1332 associated with the IABA 1300.

An adcaster monitoring module 1360 may be communicatively coupled via a path 1748 to monitoring agents (e.g., the monitoring agent 1060) associated with one or more adcasters. The adcaster monitoring module 1360 may receive real-time operational statistics from the monitoring agent 1060, including but not limited to memory, disk space, and CPU utilization, ad flow rates, a number of user sessions online at a specified point in time, and a number or rate of accepted and rejected ad bids. The statistics may be written to an adcaster performance statistics database 1364, thus traversing a path. Alternatively, or in addition, the adcaster statistics may be accumulated by the adcaster monitoring module 1360 and the accumulated statistics may be stored in the adcaster performance statistics database 1364 at a later time.

The adcaster performance statistics database 1364 may be coupled to the adcaster configuration server 1354 via a feedback path 2336. The adcaster configuration server 1354 may access adcaster statistics from the adcaster performance statistics database 1364 via the feedback path 2336 for the purpose of adjusting adcaster configurations to enhance performance.

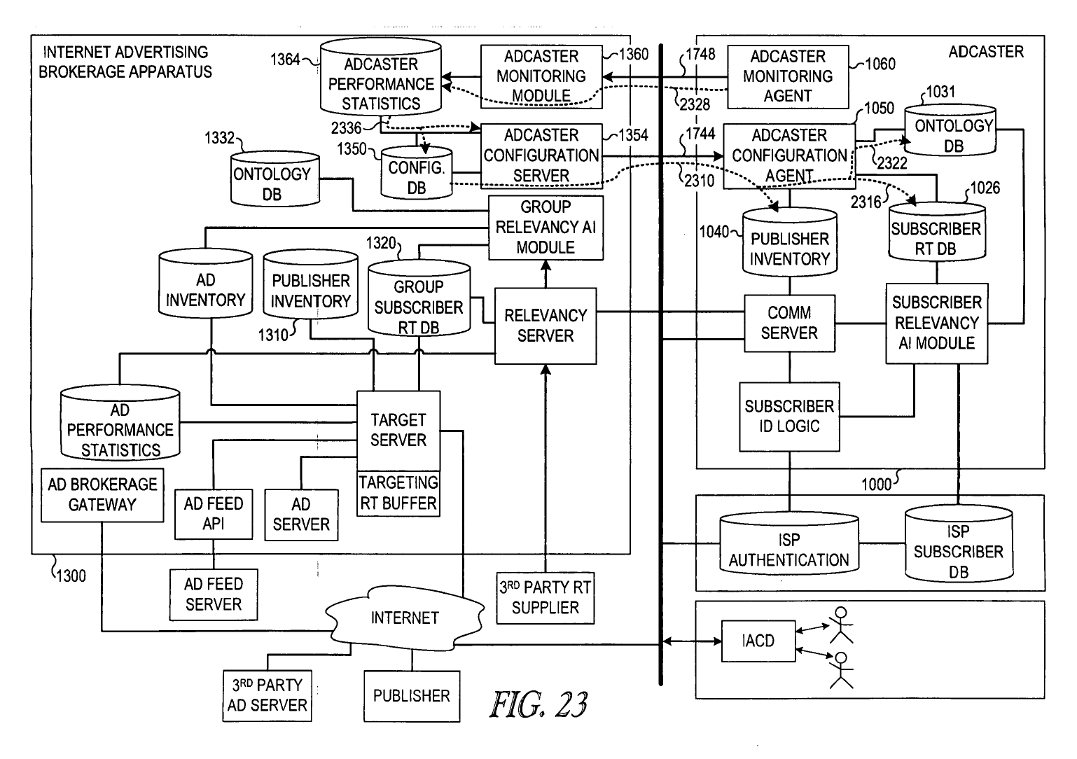

FIG. 24 is a flow diagram illustrating a method 2400 associated with adcaster configuration operations according to various example embodiments. The method 2400 may commence at block 2410 with accessing adcaster configuration parameters from a configuration database at an IABA. The method 2400 may include communicating with an adcaster configuration agent located at an adcaster, at block 2416. The method 2400 may also include populating an adcaster publisher inventory database, at block 2422. The method may further include populating an adcaster subscriber RT database, at block 2428. The method 2400 may terminate at block 2434 with populating an adcaster ontology database.

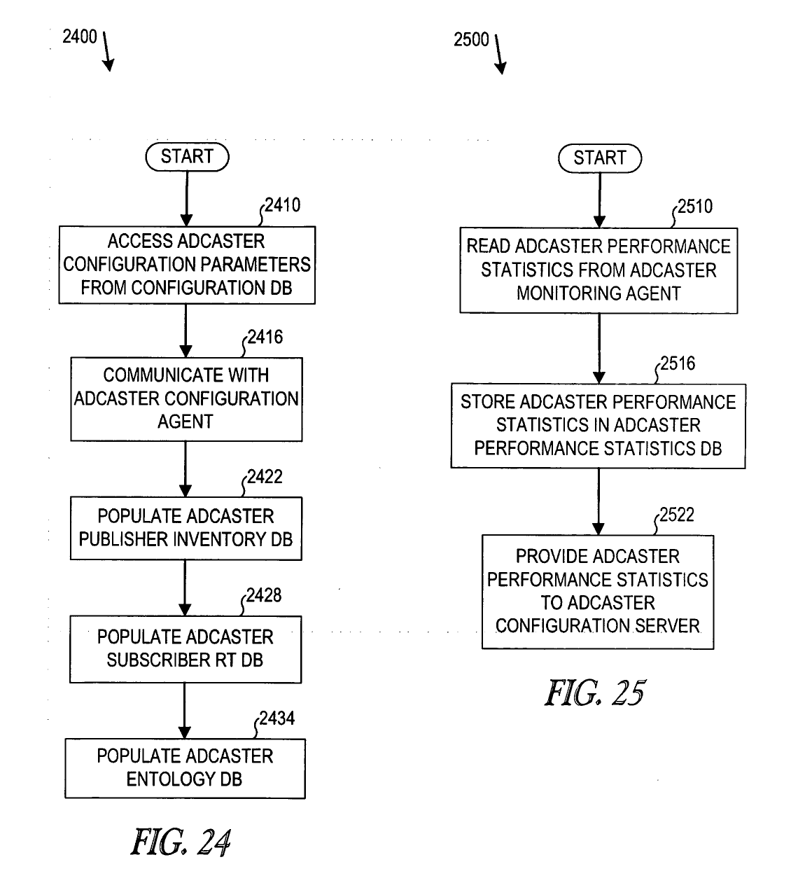

FIG. 25 is a flow diagram illustrating a method 2500 associated with adcaster monitoring operations according to various example embodiments. The method 2500 may commence at block 2510 with reading one or more sets of adcaster performance statistics, at block 2510. The method 2500 may continue with storing the adcaster performance statistics in an adcaster performance statistics database, at block 2516. The method 2500 may terminate at block 2522 with providing some or all of the adcaster performance statistics to an adcaster configuration server. The adcaster configuration server may use the performance statistics as real-time feed back to adjust adcaster configuration parameters in order to increase performance.

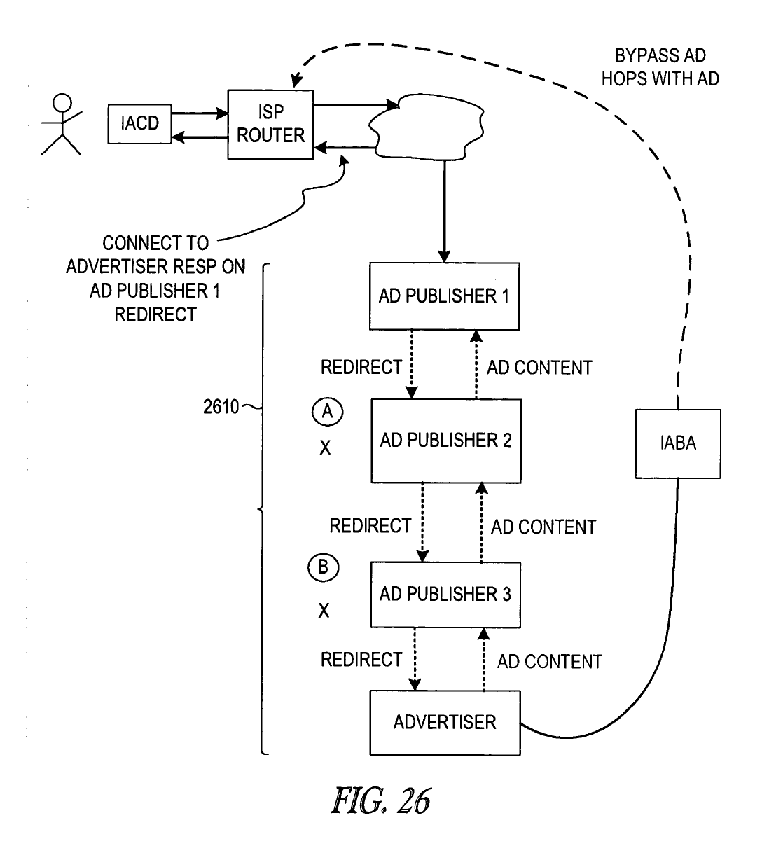

FIG. 26 is a block diagram illustrating an ad-hop bypass method and apparatus according to various example embodiments. An ad publisher receiving an ad request (e.g., ad publisher 1) may pass the ad request on to a second ad publisher (e.g., ad publisher 2) if the first ad publisher does not have an appropriate ad to satisfy the ad request. Likewise, ad publisher 2 may pass the ad request on to ad publisher 3, and so on. In an example embodiment ad advertiser may pre-populate the IABA with ads. Upon notification of an appropriate ad placement opportunity, the IABA may supply an appropriate pre-populated ad to an adcaster positioned to deliver the ad to the requesting IACD. Ad hops A and B may be thereby eliminated. A subscriber browsing at the IACD may experience more responsive browsing and internet traffic may be reduced as a result.

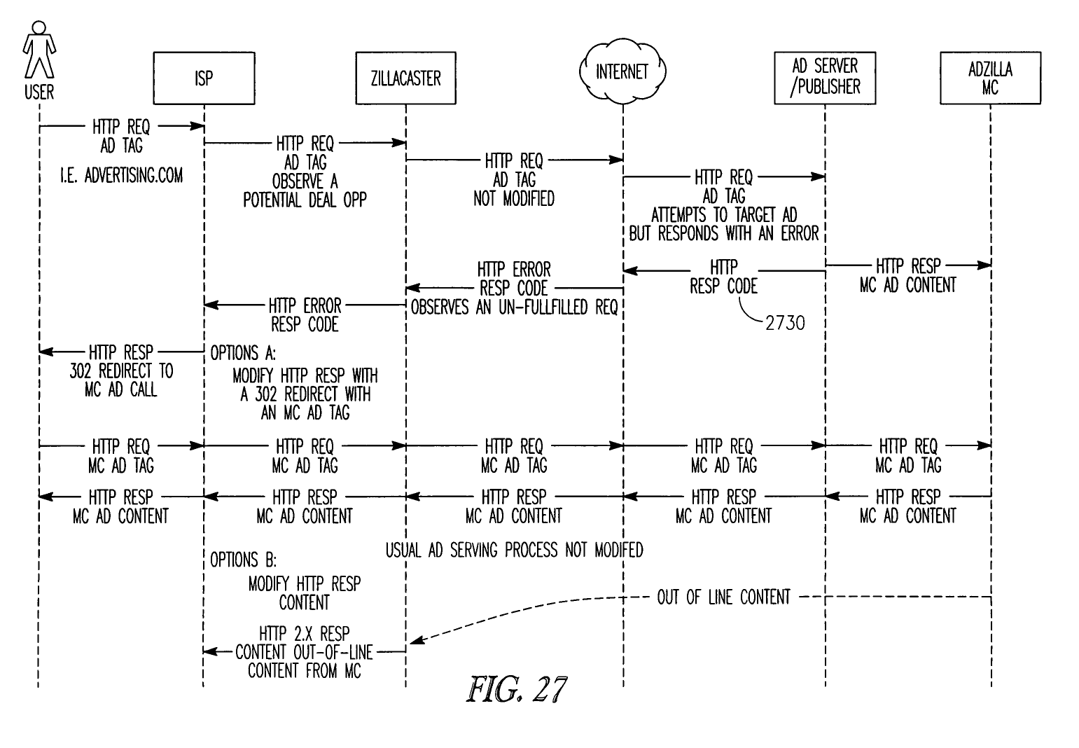

FIG. 27 is a sequence diagram illustrating an example method of trapping unfulfilled ad requests from an ad network or ad publisher. The response code 2730 may be any response indicating that a publisher is not interested in or capable of responding with an ad. Some example embodiments may modify the HTTP 302 request to the IABA. Some example embodiments may deliver the ad directly to the subscriber.

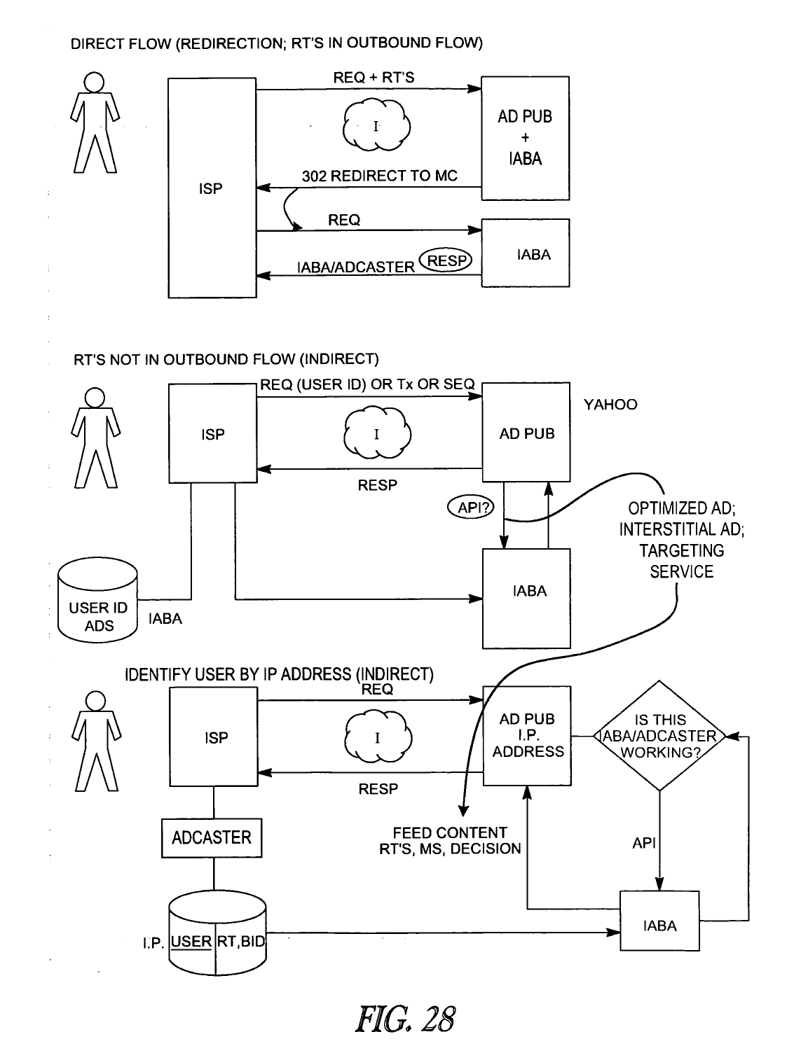

FIG. 28 is a block diagram illustrating several example methods and apparatus for directing RTs within a network. In the first example method and apparatus illustrated, RTs are inserted into the outbound redirection flow. In the second example the ad request is redirected to the IABA. The IABA then interacts directly with one or more adcasters as the ISP to deliver the appropriate ad. In the third example the user is identified by IP address. In both the second and third examples RTs may be sent using an API.

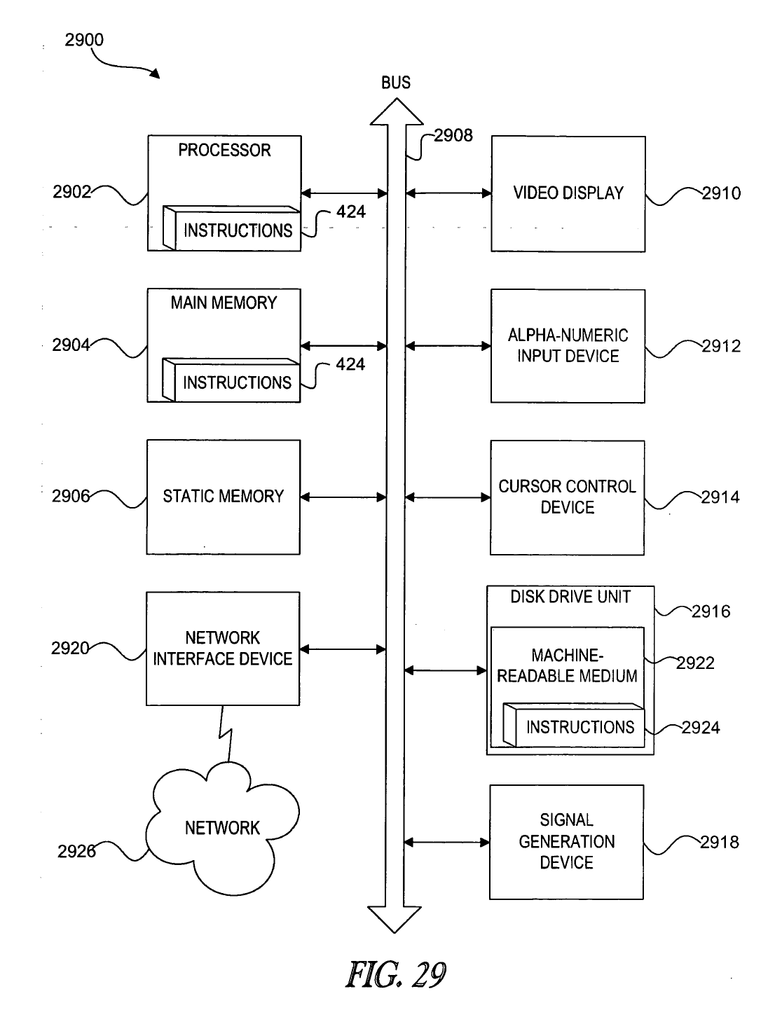

FIG. 29 is a block diagram of a computer for executing a plurality of instructions to perform one or more of the methodologies described herein according to an example embodiment. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a Web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2900 includes a processor 2902 (e.g., a central processing unit (CPU), a graphics processing unit (GPU) or both), a main memory 2904 and/or a static memory 2906, which communicate with each other via a bus 2908. The computer system 2900 may further include a video display unit 2910 (e.g., a liquid crystal display (LCD), plasma display, or a cathode ray tube (CRT)). The computer system 2900 also includes an alphanumeric input device 2912 (e.g., a keyboard), a user interface (UT) navigation device 2914 (e.g., a mouse), a disk drive unit 2916, a signal generation device 2918, and a network interface device 2920.

The disk drive unit 716 includes a machine-readable medium 2922 on which is stored one or more sets of instructions 2924 and/or data structures (e.g., software) embodying or used by any one or more of the methodologies or functions described herein. The instructions 2924 may also reside, completely or at least partially, within the main memory 2904 and/or within the processor 2902 during execution thereof by the computer system 2900, the main memory 2904 and the processor 2902 also constituting machine-readable media.

The instructions 2924 may further be transmitted or received over a network 2926 via the network interface device 2920 using any one of a number of well-known transfer protocols (e.g., FTP).

While the machine-readable medium 2922 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the example embodiments, or that is capable of storing, encoding, or carrying data structures used by or associated with such a set of instructions. The term “machine-readable medium” shall accordingly be taken to include, but not be limited to, solid-state memories, optical and magnetic media, and carrier wave signals.

The computer 2900 may be programmed to perform the functionality of the IABA embodiments, the adcaster embodiments, and/or the IACD embodiments described herein.

Some example embodiments may implement structures and methods to protect a subscriber's personal information. “Personal information” as used herein includes information which could be used to identify an individual user. Examples of such information include name, home address, and email address, among others. Some example embodiments may use aggregation techniques to protect personal information. Aggregation techniques may reduce individual transactions to counts of occurrences from a general population of subscribers. Techniques for information collection and storage whereby Personal Information is removed obscured or replaced with pseudonymic surrogates. Anonymization techniques may also be used whereby personal information is removed, obscured, and/or replaced with pseudonymic surrogates. For example, a name may be replaced with a number.

Some example embodiments may use data hashing functions to mix up user personal information to render the user information unreadable. Some example embodiments may perform irreversible hashing operations to increase anonymity. Some example embodiments may perform temporal hashing operations to create time-sensitive pseudonyms for the anonymization of user personal information. Example embodiments herein may use various containment techniques to regulate the flow of data in a privacy-preserving and privacy-enhancing way such that no personal information leaves the ISP premises. Some example embodiments of an IABA may, for example, collect only aggregated browsing information.

Privacy includes the ability of individuals to protect their personal information. Anonymity is the privacy of identity. Example embodiments herein employ anonymization techniques to protect and enhance the privacy of subscriber identities. In some example embodiments personally identifiable information does not traverse the boundaries of the IP domain associated with the ISP. Example embodiments herein may decrease the possibility of linking from aggregated and anonymized databases back to an individual identity.

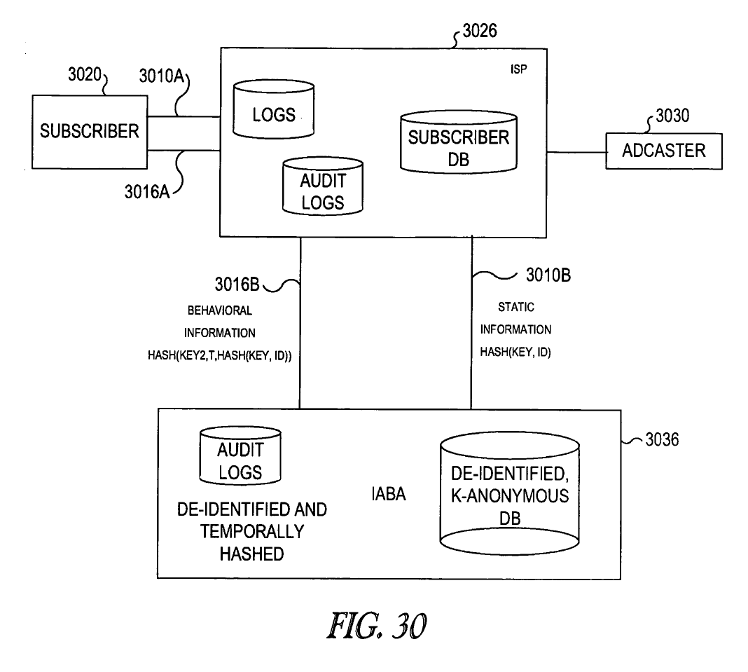

FIG. 30 is a block diagram of personal information containment architecture according to various example embodiments. Static and behavioral data flows across two data paths 3010A, 3010B and 3016A, 3016B. Subscriber information, including billing information, may be provided by a subscriber 3020 to an ISP 3026. Specific data fields of interest may include zip code, for example. The ISP 3026 may maintain a database of current subscriber information in accordance with its subscriber agreements.

An adcaster 3030 associated with the ISP 3026 and included within an IP domain associated with the ISP 3026 may use this information to localize content and enhance the browsing experience of the subscriber 3020. An anonymized subset of this information may be transferred to an IABA 3036. The anonymized data subset may be mined by media partners to answer questions such as “How many subscribers live in the 10010 zip code?” The anonymization process for subscriber data flow is described by way of example below.

Behavioral information may also be available at the ISP 3026 in the form of logs produced by ISP network equipment. The behavioral information may be available to the adcaster 3030 and may be used to further localize content and enhance the browsing experience. For example, the logs may show that a particular user has visited a certain number of fitness sites in succession. This could trigger the placement of a fitness-related advertisement on a subsequent page. Such personal information may be available only to automated processes running on the adcaster 3030.

An anonymized and aggregated subset of this information may be transferred to the IABA 3036 where it can be mined to answer questions such as “How many subscribers have visited fitness sites followed by travel sites within fifteen minutes, between the hours of 15:00 and 19:00 on Tuesdays?” An anonymization process for the behavioral data flow is described below.

Information delivered to the ISP 3026 by the subscriber 3020 in accordance with a service contract associated with the ISP 3026 is defined as personal information. The network-resident adcaster 3030 has access to this information on an ephemeral basis for the sole purpose of performing real-time calculations to optimize the delivery of content on the fly. However, example embodiments herein may render it unnecessary to transmit the information outside the domain associated with the ISP 3026.

Although the aforesaid may address privacy issues within the edge network, it may be beneficial to retain elements of the subscriber database at the IABA 3036 for purposes of data mining. The technology for data mining within this system mining may be referred to as “AIBITS” . It may tap into the transmissions associated with the adcaster 3030, analyzes the data, and aggregates groups and counts of non-specific users into statistical occurrences. Example embodiments herein may anonymize and aggregate various aspects of the information within browsing stream.

First, in an example embodiment, all actual identifying fields (e.g., name, address, telephone number, etc.) may be deleted. Next, in an example embodiment, the unique identifier (e.g., subscriber ID, IP address, etc.) may be hashed with a quantity provided by and known only by the ISP. The resulting fields are synchronized with their counterparts at the IABA 3036 and can thus yield the desired results of data mining queries without compromising subscriber identity. Some example embodiments may use k-anonymity. K-anonymity is the practice of reducing data algorithmically to create a database in which no query can result in the retrieval of less than k candidates. Some example embodiments may use this approach to reduce the information available for data mining at the IABA 3036.

Click-stream data may be available in real-time to the edge-resident adcaster 3030. Such data, collected over a long enough time interval, may provide powerful subscriber-modeling capabilities. However, the data may also represent a potential threat to privacy. A long sequence of on-line activity associated with an individual subscriber can yield substantial information that might be retroactively considered personal or private. Example embodiments herein may leverage this information in the interest of the subscriber 3020 without compromising the subscriber's privacy. This may be accomplished by temporally anonymizing the unique ID fields in the click-stream data.

Ephemeral use of browsing history to tailor content may be practiced. Thus, privacy concerns may not arise when a website looks at the referrer field in the request header to determine the prior site visited. At the opposite end of the data usage spectrum is the use of persistent (retained in near-perpetuity), comprehensive (capturing all or nearly all browsing activity) long-term (over an extended period) browsing histories for the same purpose. Such use might be considered to cross the boundary and constitute a breach of privacy. Example embodiments herein reside between these extremes, with subscriber benefit outweighing the potential costs of degraded privacy.

Example embodiments herein may implement a technique referred to as “temporal anonymization” or periodic pseudonymity. First, in an example embodiment, the unique IDs in the click-stream may be hashed with a unique quantity known only to the ISP 3026. The result may then be further hashed against a random quantity that changes on a periodic basis and another unique quantity known only to the ISP.

While it may be possible to configure campaigns to deliver specific content e.g., “everyone in the 10001 postal code who has visited golf sites AND piano tuning sites within the last T seconds,” example embodiments herein may prevent the IABA 3036 from linking browsing history in this way back to customers subscriber information maintained by the ISP 3026. Thus, a strong and clear separation forms elements of the disclosed containment architecture; and this helps to ensure subscriber privacy.

In general, there may be two principal uses to which data is put in these example embodiments. Adcasting customizes content delivery to improve the browsing experience for the end user. This may includes localization of advertising content by supporting the specification of localized advertising campaigns and the subsequent delivery of localized advertising material. A secondary example use of data acquired in the course of adcasting example embodiments is the mining of this data to reveal trends and develop models to further refine and improve the browsing experience.

Campaigns are specified in the IABA 3036. The IABA may remain outside the environment associated with the ISP 3026 where the adcaster 3030 is installed and hosted. The Graphical User Interface (GUI) may be designed to support secure ad campaigns an may allow the specification of delivery targets expressed in terms of (a) non-personal user attributes including geo-coordinates; (b) a series of time intervals, campaign objectives, and advertisement bid opportunities; (c) information needed to connect ad content distribution to web Publishers or ad networks, and tracking of performance of ad deliveries.

For instance, in an example embodiment, a complete specification of a campaign may comprise a link to the content to be displayed, and an intentional description of the target (e.g., “all browsers belonging to subscribers in the 10010 zip code equipped with high speed internet access on Mondays, Wednesdays and Thursdays between 17:00 and 21:00 during the month of June”). Although a media representative authoring this campaign may not determine the identities of the eventual recipients of the campaign, that entity will have been able via the data mining functions of the IABA 3036 to determine a priori the potential size of the target audience. The media representative may also receive detailed, auditable post-campaign reports regarding the effectiveness of the campaign. The campaign may be monitored in real time and fine-tuned to achieve desired results.

Embodiments herein may accomplish these objectives while maintaining the privacy of a targeted subscriber. In an example embodiment, the containment architecture and the concept of making relevant decisions about how best to hand-off requests to the most opportunistic network partner or advertiser, and who can deliver the most cost effective ad opportunity may offer a solution. This can be thought of as changing the direction of the ad request in favor of a better, higher yielding, and more relevant opportunity. In an example embodiment this may be done with permission of the owner's originating request and usually a basis of economic benefit to the originating stakeholder.

Hence instead of a request that is destined to ValueClick®, the adcaster 3030 may redirect the request in real-time so that it arrives to the highest yield or highest bided opportunity. There are many techniques used to make the predictions. One aspect involves invoking the ad opportunity at the right time. The second is the ability to make a comparative decision that determines the relevancy of the original ad opportunity (normal browsing) versus a more relevant opportunity. Leveraging the persistency of the browsing stream data associated with the ISP 3026 to making the right decision at the right time about ad opportunities may increase the value of the ad space and further may create a better more relevant browsing experience for the end-user.

When the adcaster 3030 processes user requests for information, it may evaluate each request transparently in real time to see if a more opportunistic decision can be made. In an example embodiment, the adcaster 3030 may do this by hashing the ID of the requesting subscriber 3020 with the ISP's key. The evaluation may be made using the following factors:
The arbitrage opportunity of the ad distribution. Low priced ad inventory versus more premium ad yields.
A biding process that allows market value of certain type of ads to be connected better to a more guaranteed delivery message to the subscriber.
The permission of a deal property (WP) and the negotiated rates for acquiring media space.
The ability to use IABA 3036 data mining to make real-time predictions about statistically based trends.
Avoiding ad delivery weaknesses, such as eliminating known untargeted/wasteful ads from an ad network (e.g. backfilling) and replacing such ads with more targeted and relevant opportunities
The arbitrage opportunity of the ad distribution. Low priced ad inventory versus more premium ad yields.
A biding process that allows market value of certain type of ads to be connected better to a more guaranteed delivery message to the subscriber.

Example embodiments herein may take advantage of this extensive literature and combine security technology to achieve powerful data mining functionality and privacy protection. A network operator using example embodiments as described herein may disseminate a privacy statement similar to the following to communicate aspects of the example embodiments and their consequences to a subscriber.

### NETWORK OPERATOR Privacy Policy

### (Date of Dissemination)

NETWORK OPERATOR is dedicated to the protection of privacy. The NETWORK OPERATOR Technology and NETWORK OPERATOR Services adhere to the following policies:

NETWORK OPERATOR is committed to protecting the privacy of ISP end users. This document is an explanation of NETWORK OPERATOR's Privacy Policy for ISP end users (“End Users”). This Policy applies to all of the products and services offered by NETWORK OPERATOR Inc. or its subsidiaries (collectively, NETWORK OPERATOR “products”).

NETWORK OPERATOR adheres to the US safe harbor privacy principles of Notice, Choice, Onward Transfer, Security, Data Integrity, Access and Enforcement.

### Information Collected and Its Use

Information That the End User Provides to ISPs

When the End User signs up for Internet service, the End User provides the ISP with personal information. The ISP may provide NETWORK OPERATOR with access to this information so that NETWORK OPERATOR can provide the End User with a better Internet browsing experience and to improve the quality of NETWORK OPERATOR's service. At no time will the End Users' personal information leave the ISP.

Cookies

NETWORK OPERATOR's ad serving partners may send the End User one or more “cookies.” A cookie in this context is a small file containing a string of characters that uniquely identifies the End Users' browser. Cookies are used to improve the quality of the ad serving partners' service by limiting ad display frequency, storing user preferences and tracking user trends. Most browsers are initially set up to accept cookies, but the End User can reset their browser to refuse all cookies or to indicate when a cookie is being sent. However, some features and services may not function properly if the End Users' cookies are disabled.

Log Information

When the End User uses certain NETWORK OPERATOR products (such as an adcaster), NETWORK OPERATOR's servers automatically record information that the End Users' browser sends whenever the End User visits a website. These server logs may include information such as the End Users' web request, Internet Protocol address, browser type, browser language, and the date and time of the End Users' request.

User Communication

When the End User sends email or other communication to NETWORK OPERATOR, NETWORK OPERATOR may retain those communications in order to process the End Users' inquiries, respond to the End Users' requests and improve NETWORK OPERATOR's service.

Affiliated Sites

NETWORK OPERATOR offers some of its services in connection with other web sites. Personal information that the End User provides to those sites may be sent to NETWORK OPERATOR in order to deliver the service. NETWORK OPERATOR processes such information in accordance with this Policy. The affiliated sites may have different privacy practices and NETWORK OPERATOR encourages you to read their privacy policies.

NETWORK OPERATOR only processes personal information for the purposes described in this Privacy Policy. In addition to the above, such purposes might include:
Providing NETWORK OPERATOR products and services to users, including the display of customized content and advertising;
Auditing, research, and analysis in order to maintain, protect and improve our services;
Ensuring the technical functioning of NETWORK OPERATOR's network; and/or
Developing new services.

### Choices for Personal Information

If NETWORK OPERATOR proposes to use personal information for any purpose other than those described in this Policy, NETWORK OPERATOR will offer you an effective way to opt out of the use of personal information for those other purposes. NETWORK OPERATOR will not collect or use any information relating to confidential medical information, racial or ethnic origins, political or religious beliefs or sexuality and tied to personal information (“sensitive personal information”) for purposes other than those described in this Policy, unless NETWORK OPERATOR has obtained your prior consent.

So long as your ISP assigns you a static IP address or RADIUS identifier, you may choose to opt-out of NETWORK OPERATOR's services at any time.

### Information Sharing

NETWORK OPERATOR only shares personal information with other companies or individuals outside NETWORK OPERATOR in the following limited circumstances:

NETWORK OPERATOR has your consent. NETWORK OPERATOR requires opt-in consent for the sharing of sensitive personal information.

NETWORK OPERATOR provides such information to its subsidiaries, affiliated companies or other trusted businesses or persons for the purpose of processing personal information on its behalf. NETWORK OPERATOR requires that these parties agree to process such information based on NETWORK OPERATOR's instructions and in compliance with this Policy and any other appropriate confidentiality and security measures.

NETWORK OPERATOR has a good faith belief that access, use, preservation or disclosure of such information is reasonably necessary to (a) satisfy any applicable law, regulation, legal process or enforceable governmental request; (b) enforce applicable Terms of Services including investigation of potential violations thereof; (c) detect, prevent, or otherwise address fraud, security or technical issues; or (d) protect against imminent harm to the rights.

If NETWORK OPERATOR becomes involved in a merger, acquisition, or any form of sale of some or all of its assets, it will provide notice before personal information is transferred and becomes subject to a different privacy policy.

NETWORK OPERATOR may share with third parties certain pieces of aggregated, non-personal information, such as the number of users who browsed to a certain website, for example, or how many users clicked on a particular advertisement. Such information does not identify the End User individually.

Please contact NETWORK OPERATOR at the address below for any additional questions about the management or use of personal data.

### Information Security

NETWORK OPERATOR takes appropriate security measures to protect against unauthorized access to or unauthorized alteration, disclosure or destruction of data. These include internal reviews of NETWORK OPERATOR's data collection, storage and processing practices and security measures, as well as physical security measures to guard against unauthorized access to systems where NETWORK OPERATOR stores personal data.

NETWORK OPERATOR restricts access to NETWORK OPERATOR employees, contractors and agents who need to know that information in order to operate, develop or improve its services. These individuals are bound by confidentiality obligations and may be subject to discipline, including termination and criminal prosecution, if they fail to meet these obligations.

### Data Integrity

NETWORK OPERATOR processes personal information only for the purposes for which it was collected and in accordance with this Policy. NETWORK OPERATOR reviews its data collection, storage and processing practices to ensure that NETWORK OPERATOR only collects, stores and processes the personal information needed to provide or improve its services. NETWORK OPERATOR takes reasonable steps to ensure that the personal information processed is accurate, complete, and current, but NETWORK OPERATOR depends on its users and partners to update or correct personal information whenever necessary.

### Enforcement

NETWORK OPERATOR regularly reviews its compliance with this Policy. Please feel free to direct any questions or concerns regarding this Policy or NETWORK OPERATOR's treatment of personal information by contacting NETWORK OPERATOR by email at privacy@NETWORK OPERATOR.com or by writing to NETWORK OPERATOR at (NETWORK OPERATOR address). When NETWORK OPERATOR receives formal written complaints at this address, it is NETWORK OPERATOR's policy to contact the complaining user regarding his or her concerns. NETWORK OPERATOR will cooperate with the appropriate regulatory authorities, including local data protection authorities, to resolve any complaints regarding the transfer of personal data that cannot be resolved between NETWORK OPERATOR and an individual.

### Changes to This Policy

Please note that this Privacy Policy may change from time to time. NETWORK OPERATOR will not reduce your rights under this Policy without your explicit consent, and NETWORK OPERATOR expects such changes will be minor. Regardless, NETWORK OPERATOR will post any Policy changes on this page and, if the changes are significant, NETWORK OPERATOR will provide a more prominent notice. Each version of this Policy will be identified at the top of the page by its effective date.

If there are any additional questions or concerns about this Policy, please feel free to contact NETWORK OPERATOR at any time by email at privacy@NETWORK OPERATOR.com or by writing NETWORK OPERATOR at (NETWORK OPERATOR's address).

### Architecture Description

Embodiments herein may safeguard end user information using apparatus, systems, and methods according to the following example architecture. Embodiments may use anonymization techniques described herein to protect the privacy of subscriber identities and to safeguard against the possibility of linking aggregated and anonymized databases to individual identities.

### Containment Architecture

1. Static User Information

Static user information is provided by the subscriber to the ISP, and includes, among other things, billing information. The ISP maintains a database of current subscriber information in accordance with its subscriber agreements. The adcaster accesses the information from within the ISP premises in order to localize content and enhance the subscribers' browsing experiences. An anonymized, aggregated subset of this information is transferred to the NETWORK OPERATOR IABA system, where it can be mined by media partners to answer questions like: “How many subscribers live in the 10010 zip code?” The anonymization process for the Subscriber data flow is described below.

2. Dynamic Behavior Information

Behavioral information is also available from the ISP in the form of logs produced by the ISP's network equipment. This information may be accessed by the adcaster and is used to deliver more relevant content to the end user, thus enhancing the user's the browsing experience. For example, the logs will show that a particular user has visited a number of real estate sites over a short period of time, which could trigger the placement of a mortgage-related advertisement on a subsequent page. This information is available only to the automated processes running on the adcaster.

An anonymized and aggregated subset of this information is transferred on a regular basis to the NETWORK OPERATOR IABA where it can be mined to answer questions like: “How many subscribers have visited more than three real estate-related sites within fifteen minutes, between the hours of 15:00 and 19:00 on Tuesdays?” The anonymization process for the Behavioral data flow is described below.

In order to benefit from data-mining processes while protecting privacy, NETWORK OPERATOR keeps an ephemeral log (where entries expire after period T) that resides only in the ISP premise and not at all in the NETWORK OPERATOR IABA. The NETWORK OPERATOR IABA keeps only an Audit Log that contains the minimum information required to demonstrate that it has met the business commitments of the various media campaigns.

Subscriber Information Data Flow and Transformations

NETWORK OPERATOR considers subscriber information submitted to the ISP by the subscriber in accordance with the ISP's service contract to be PII. No PII is ever in NETWORK OPERATOR's possession. While the network-resident adcaster can access this information on an ephemeral basis, this information never leaves the ISP.

While this effectively addresses privacy issues within the edge network, there remains a need to retain elements of the subscriber database at NETWORK OPERATOR IABA for data mining; this must be accomplished without compromising end user privacy. The technology for data mining within the NETWORK OPERATOR IABA system is called “Relevancy AI”. Relevancy AI receives transmissions from the adcaster and then analyzes, counts, and groups non-specific users into statistical occurrences. This is accomplished by anonymizing and aggregating all aspects of the information obtained from the browsing stream.

Removing Personally Identifiable Information

First, all fields containing PII are deleted, including name, address, telephone number, etc. Fields containing postal codes and street names are retained without compromising privacy under conditions of k-anonymity as described below. Next, a unique identifier is assigned by operation of a cryptographic hash function known only by the ISP to anonymize the subscriber's IP address. This quantity can be provided, for example, by a secure cryptographic device attached to the adcaster. The resulting fields may be synchronized with their counterparts at a NETWORK OPERATOR IABA, and can yield the desired results of data mining queries without compromising subscriber identity.

k-anonymity

The practice of reducing data algorithmically to create a database in which no query can result in the retrieval of less than k candidates is referred to as k-anonymity. Embodiments herein may use these techniques to reduce the information available for data mining at the NETWORK OPERATOR IABA.

Behavioral Information Data Flow and Transformations

Click-stream data is available in real-time to the edge-resident adcaster appliance. Such data, collected over a sufficient time interval, provides powerful subscriber-modeling capabilities and also represents a potential threat to subscriber privacy. A long sequence of on-line activity could yield substantial information that might be considered personal or private if attached to an individual subscriber. Embodiments herein may seek to leverage this information to the benefit of the subscriber without compromising the subscriber's privacy. This may be accomplished by temporally anonymizing the unique ID fields in the click-stream data, among other techniques.

Some embodiments may make ephemeral use of browsing history to tailor content. For example, there are no privacy concerns when a website looks at the referrer field in the request header to determine the prior site visited by the user. This is the trivial end of the click-stream data exploitation spectrum. At the opposite end of the same spectrum is the use of persistent (retained in near-perpetuity), comprehensive (capturing all or nearly all browsing activity) long-term (over an extended period) browsing histories for the same purpose. Without informed consent, such use of browsing history would be considered to constitute a breach of privacy. Through notice and opt-out provisions, embodiments herein may support user decision-making as to whether the benefit of personalized content outweighs the potential costs of degraded privacy. Embodiments herein may seek to determine the optimal point on the spectrum where a large number of users decide not to opt-out. Such mechanisms may support flexibility as to user privacy in light of ever-changing market demands and societal norms.

Embodiments herein may employ a technique referred to as “temporal anonymization.” As with static subscriber information, temporal anonymization may begin by hashing the unique IDs in the click-stream with a unique quantity known only to the ISP. The resulting value may then be further hashed against a random quantity that changes on a periodic basis, as well as yet another unique quantity known only to the ISP. This latter value is distinct from the value used in the subscriber transformation algorithm, but can be provided by the same crypto device. This method prevents us from answering questions like: “how many people in zip code 11111 visited real estate sites.”

While it is possible to configure campaigns to deliver advertising to a set of parameters such as: “Everyone in the 10001 postal code who has visited golf sites AND piano tuning sites within the last T minutes,” it may not be possible for the NETWORK OPERATOR IABA system to link browsing history back to the Service Providers customer's subscriber information. The enforcement of this strong and clear separation forms the crux of NETWORK OPERATOR's Containment Architecture.

### Use of Data

In general, data has two principal uses in the adcasting paradigm. The first and primary use of data is to customize content delivery in order to improve the end user's browsing experience. An example would be localization of advertising content. A secondary use of data acquired in the course of adcasting is the mining of this data to reveal trends and develop models to further refine and improve the browsing experience. These uses of adcasting data are consistent with the guidelines already established. This section details the methods and algorithms that support these uses.

NETWORK OPERATOR IABA Campaign Specification and Delivery With Adcasting.

Advertising campaign specifications are set forth in the NETWORK OPERATOR IABA. The system operates outside of Service Providers premises, where adcasters are installed and hosted. The NETWORK OPERATOR IABA Graphical User Interface (GUI) allows the specification of delivery targets expressed in terms of:
Non-personal user attributes including interest categories, keywords, and geo-coordinates;
A series of time intervals, campaign objectives, and advertisement bid opportunity; and/or
Information needed to connect ad content distribution to Web Publishers or Ad Networks, and tracking of performance of ad deliveries.

For example, a complete advertising campaign specification would consist of a link to the advertising content (“Creative”) to be displayed, and a description of the target audience, e.g., “all subscribers in the 10010 postal code equipped with high speed internet access on Mondays, Wednesdays and Thursdays between 1700 and 2100 during the month of June.” While the advertiser cannot determine the identities of the eventual recipients of the campaign, it will be able via the data mining functions of the NETWORK OPERATOR IABA to estimate the potential size of the target audience, and will receive detailed, auditable real-time reports regarding the delivery of the campaign. The campaign can also be monitored and changed in real time, to achieve desired results.

Embodiments herein accomplish these objectives while maintaining subscriber privacy. The containment architecture is the key to evaluating advertising opportunities. In effect, this changes the direction of the ad request in order to deliver a better, higher yielding, and more relevant opportunity.

With the consent of the web publisher, an ad-call request that would otherwise be sent to an advertising network like ValueClick®, is intercepted by the adcaster in real-time when an adcaster enabled user browses to the web publisher's web site, so that it arrives to a more relevant advertising opportunity. Embodiments herein may use various techniques used to make the predictions. Leveraging a service provider's browsing stream data to make the right decision at the right time about ad opportunities significantly increases the value of the ad space and further creates a more relevant browsing experience for the end-user.

When the adcaster processes user requests for information, it evaluates each request transparently in real time to see if a more opportunistic decision can be made. The adcaster does this by hashing the ID of the requesting subscriber with the ISP's key. The evaluation is made using the following factors:

Data Mining

Embodiments herein use and re-use data sets in statistical analyses to yield a range of solutions and to strike a careful balance between the usefulness of the information and the privacy of the information donors. Adcasting utilizes methods described herein to achieve powerful data mining functionality and uncompromising privacy protection.

The accompanying drawings that form a part hereof show, by way of illustration and not of limitation, particular example embodiments in which the subject matter may be practiced. The example embodiments illustrated are described in sufficient detail to enable those skilled in the art to practice the teachings disclosed herein. Other example embodiments may be used and derived therefrom, such that structural and logical substitutions and changes may be made without departing from the scope of this disclosure. This Detailed Description, therefore, is not to be taken in a limiting sense. The scope of various example embodiments is defined by the appended claims and the full range of equivalents to which such claims are entitled.

Such example embodiments of the inventive subject matter may be referred to herein individually or collectively by the term “invention” merely for convenience and without intending to voluntarily limit the scope of this application to any single invention or inventive concept, if more than one is in fact disclosed. Thus, although specific example embodiments have been illustrated and described herein, any arrangement calculated to achieve the same purpose may be substituted for the specific example embodiments shown. This disclosure is intended to cover any and all adaptations or variations of various example embodiments. Combinations of the above example embodiments and other example embodiments not specifically described herein will be apparent to those of skill in the art upon reviewing the above description.

The Abstract of the Disclosure is provided to comply with 37 C.F.R. §1.72 (b) requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single example embodiment for the purpose of streamlining the disclosure. This method of disclosure is not to be interpreted to require more features than are expressly recited in each claim. Rather, inventive subject matter may be found in less than all features of a single disclosed example embodiment. Thus the following claims are hereby incorporated into the Detailed Description, with each claim standing on its own as a separate example embodiment.

What is claimed is:

1. An apparatus, comprising:
a group subscriber relevancy tag (RT) database at an internet advertising brokerage apparatus (IABA) to contain a set of RT records associating a user identification with at least one RT;
an advertisement inventory database communicatively coupled to the group subscriber RT database to contain a set of advertisement records, each advertisement record associating an advertisement with a set of RT requirements; and
a target server to receive an advertisement request with a user identification, to search the group subscriber RT database for the at least one RT, to match the at least one RT to the set of RT requirements, to place a bid for an advertisement placement opportunity associated with the advertisement request, and to pass the at least one RT to a content publisher associated with the advertisement request.

2. The apparatus of claim 1, wherein a record associated with the advertising inventory database comprises at least one of an advertisement code field, a sale amount field, a billing terms field, a purchase mode field, a basis field, a delivery method field, a run period field, an RT requirements field, and an advertisement content address field.

3. The apparatus of claim 1, further comprising:
a publisher inventory database communicatively coupled to the target server to provide additional RTs to the target server.

4. The apparatus of claim 1, further comprising:
a targeting RT buffer coupled to the target server to accumulate RTs used to find the advertisement at the advertisement inventory database.

5. The apparatus of claim 1, further comprising:
an advertisement performance statistics database coupled to the target server to accumulate statistics associated with amounts bid for advertisement placement opportunities over periods of time associated with multiple advertisement placement transactions.

6. The apparatus of claim 5, further including:
a primary publisher record associated with the advertisement performance statistics database, the primary publisher record comprising at least one of a publisher code field, an advertisement identifier field, a cumulative number of bids won field, a cumulative number of bids lost field, a price of a bid last won field, or a price of a bid last lost field.

7. The apparatus of claim 6, further including:
a transaction record associated with the primary publisher record in a one-to-many relationship, the transaction record comprising at least one of an advertisement identification field, a time field, a bid status field, or a cost field.

8. The apparatus of claim 1, further comprising:
an advertisement server to supply an advertisement in response to the advertisement request.

9. The apparatus of claim 1, further comprising:
an advertisement feed application programming interface (API) to receive an advertisement from an advertisement feed server external to the IABA to supply in response to the advertisement request.

10. An apparatus, comprising:
a relevancy server to receive relevancy tags (RTs);
a group relevancy module communicatively coupled to the relevancy server to enhance and expand the RTs; and
a group subscriber RT database to store received, enhanced, and expanded RTs.

11. The apparatus of claim 10, further comprising:
an ontology database communicatively coupled to the group relevancy module to receive selected RTs from the group relevancy module and to return the expanded RTs.

12. The apparatus of claim 11, wherein a record associated with the ontology database comprises at least one of a uniform resource locator (URL) field, an indexed keyword field, or a list of associated category keywords.

13. The apparatus of claim 10, further comprising:
a path from a subscriber RT database associated with an access stream intercept device (ASID), the path communicatively coupled to the relevancy server to receive a selected subset of the RTs from the subscriber RT database.

14. The apparatus of claim 10, further comprising:
a path from a third-party RT supplier, the path from the third-party RT supplier coupled to the relevancy server to receive a selected subset of the RTs from the third-party RT supplier.

15. The apparatus of claim 10, further comprising:
a publisher inventory database communicatively coupled to the relevancy server to provide a selected subset of the RTs.

16. The apparatus of claim 10, further comprising:
an advertisement performance statistics database communicatively coupled to the group relevancy module, the advertisement performance statistics database to supply accumulated statistics associated with amounts bid for advertisement placement opportunities over periods of time associated with multiple advertisement placement transactions, the accumulated statistics to be used by the group relevancy module to enhance trending operations associated with at least one of an accumulation of relevancy information or a synthesis of additional RTs from accumulated RTs.

17. An apparatus, comprising:
an access stream intercept device (ASID) monitoring module to receive operational statistics from at least one ASID; and
an ASID performance statistics database communicatively coupled to the ASID monitoring module to store the operational statistics.

18. An apparatus, comprising:
an advertising network configuration database to receive configuration parameters from an advertising network manager and to store the parameters; and
an access stream intercept device (ASID) configuration server communicatively coupled to the advertising network configuration database to send ASID configuration parameters and ASID database loads to at least one ASID.

19. The apparatus of claim 18, further including:
a special listing record associated with the advertising network configuration database, the special listing record comprising at least one of a uniform resource locator (URL) field, a special listing field, or a field containing a reason for the special listing.

20. The apparatus of claim 18, further including:
an advertisement placement opportunity record associated with the advertising network configuration database, the advertisement placement opportunity record comprising at least one of a host name match field, a uniform resource locator (URL) name match field, a supported advertisement methods field, a transform scripts field, or a custom RTs field.

21. The apparatus of claim 18, further including:
a customer configuration record associated with the advertising network configuration database, the customer configuration record comprising at least one of an internet service provider (ISP) field, an enabled services field, an ASID group field, an RT static mappings field, an advertisement rules field, or a privacy policy field.

22. The apparatus of claim 18, further including:
a data mining script pointer record associated with the advertising network configuration database, the data mining script pointer record comprising at least one of a script code field, a script purpose field, a host match field, a uniform resource locator (URL) match field, an event triggers field, or an invocation field.

23. The apparatus of claim 18, further comprising:
an ASID monitoring module communicatively coupled to the ASID configuration server to receive operational statistics from the at least one ASID; and
an ASID performance statistics database communicatively coupled to the ASID monitoring module, the ASID performance statistics database to provide the operational statistics to at least one of the advertising network configuration database or the ASID configuration server to implement a closed-loop advertising network configuration system.

24. An apparatus, comprising:
a communication server to receive redirected hypertext transport protocol (HTTP) requests from an internet access computing device (IACD) and to receive redirected HTTP responses to the requests; and
a subscriber relevancy module communicatively coupled to the communication server to extract stream relevancy tag (RT) data from the requests and the responses, to receive external RT data, to enhance the stream RT data and the external RT data, and to insert enhanced RT data into at least one of the requests or the responses.

25. The apparatus of claim 24, wherein the communication server and the subscriber relevancy module are integrated into at least one of a data packet router or a data packet switch.

26. The apparatus of claim 24, further comprising:
a subscriber RT database communicatively coupled to the subscriber relevancy module to store accumulated RT data.

27. The apparatus of claim 26, wherein a record associated with the subscriber RT database comprises at least one of a user identification field, a record creation date and time field, a session identification field, a session link identification field, an RT source field, an RT field, an RT literal field, or a propensity field.

28. The apparatus of claim 24, further comprising:
an application process executing on at least one of a server, a specialty hardware device, a network interface card (NIC), a proxy server, a deep packet inspection device, a switch, or a router, the application process to redirect the HTTP requests to the communications server.

29. The apparatus of claim 28, wherein the application process comprises at least one of a remote procedure call, an interprocess communication interface, or an application programming interface (API).

30. The apparatus of claim 24, further comprising:
an ASID ontology database communicatively coupled to the subscriber relevancy module to receive RT data from the subscriber relevancy module and to return the enhanced RT data to the subscriber relevancy module.

31. The apparatus of claim 24, further comprising:
a monitoring agent communicatively coupled to the communication server to capture and store ASID operational statistics.

32. The apparatus of claim 24, further comprising:
a configuration agent communicatively coupled to the communication server to receive configuration parameters and database loads from an advertising network controller.

33. The apparatus of claim 24, further comprising:
a publisher inventory database communicatively coupled to the communication server to contain information linking website publisher advertisement space to RTs selected by the subscriber relevancy module.

34. The apparatus of claim 33, wherein a record associated with the publisher inventory database comprises at least one of a field containing a publisher code and publisher uniform resource locator (URL), a billing terms field, an acquisition mode field, a cost field, a minimum bid field, a position field, a size field, or a field containing at least one mapped RT.

35. The apparatus of claim 24, further comprising:
subscriber identification (ID) logic coupled to the subscriber relevancy module to identify at least one of a subscriber or a user session associated with the HTTP requests.

36. A system, comprising:
a communication server at an access stream intercept device (ASID) to receive redirected hypertext transport protocol (HTTP) requests from an internet access computing device (IACD) and to receive redirected HTTP responses to the requests;
a subscriber relevancy module communicatively coupled to the communication server to extract stream relevancy tag (RT) data from the requests and the responses, to receive external RT data, to enhance the stream RT data and the external RT data, and to insert enhanced RT data into at least one of the requests or the responses;
a relevancy server at an internet advertising brokerage apparatus (IABA) communicatively coupled to the ASID to receive relevancy tags (RTs) from the ASID;
a group relevancy module communicatively coupled to the relevancy server to enhance and expand the relevancy tags; and
a group subscriber RT database to store received, enhanced, and expanded relevancy tags.

37. The system of claim 36, wherein the ASID is located at an internet service provider (ISP) associated with the IACD.

38. The system of claim 37, wherein the ISP comprises at least one of a dial-up ISP, a DSL ISP, a cable ISP, a wireless ISP, or a satellite communications service provider.

39. The system of claim 36, wherein the ASID is associated with an upstream provider of internet bandwidth to at least one internet service provider (ISP) associated with the IACD.

40. The system of claim 36, wherein the ASID is associated with a hosted services provider, wherein the hosted services provider receives an advertising request packet initiated at the IACD and redirected to the hosted services provider by at least one internet service provider topologically located between the IACD and the hosted services provider, and wherein the hosted services provider appends at least one RT to the advertising request packet.

41. The system of claim 36, wherein the ASID is associated with a third-party service provider, wherein the third-party service provider supplies an internet-based service to a subscriber associated with the IACD.

42. The system of claim 41, wherein the internet-based service comprises at least one of a browsing acceleration service, a security filtering service, a parental blocking service, a spyware detection and removal service, a phishing notification service, an ad blocking service, an email service, or an application hosting service.

43. The system of claim 36, further comprising:
a cooperative software agent executed by the IACD to communicate with at least one of the ASID or the IABA and to provide additional relevancy information known to the IACD.

44. The system of claim 43, wherein the additional relevancy information comprises at least one of a MAC address, a CPU serial number, operating system desktop-related information, authentication-authorization-accounting (AAA) service information, ISP-based subscriber information, or information related to an interaction between processes executing on the IACD.

45. A system, comprising:
a subscriber relevancy module at an access stream intercept device (ASID) to redirect an advertisement request with a user identification to an internet advertising brokerage apparatus (IABA);
a group subscriber relevancy tag (RT) database at the IABA, the group subscriber RT database communicatively coupled to the ASID to contain a set of RT records associating the user identification with at least one RT;
an advertisement inventory database communicatively coupled to the group subscriber RT database to contain a set of advertisement records, each advertisement record associating an advertisement with a set of RT requirements;
a target server communicatively coupled to the group subscriber RT database, the target server to search the group subscriber RT database for the at least one RT, to match at least one RT to the set of RT requirements, to place a bid for an advertisement placement opportunity associated with the advertisement request, and to pass the at least one RT to a content publisher associated with the advertisement request.

46. The system of claim 45, wherein the ASID is located at an upstream provider, the upstream provider located at a position upstream from an internet service provider (ISP) associated with the user identification.

47. The system of claim 35, further including:
an advertisement brokerage gateway communicatively coupled to at least one of the group subscriber RT database, the advertisement inventory database, a publisher inventory database, an advertisement performance statistics database, an ASID configuration database, or an ASID performance database to provide authorized personnel with access to databases and configuration mechanisms associated with the IABA.

48. A system, comprising:
an access stream intercept device (ASID) to receive redirected datastreams associated with a plurality of subscribers and to append relevancy information to the redirected datastreams;
a regional internet advertising brokerage apparatus (IABA) to receive the relevancy information and advertisement requests from the ASID and to provide regionally-enhanced relevancy information and bids for regional advertisement placement opportunities associated with the advertisement requests to an advertising brokerage network;
a continental IABA to receive the regionally-enhanced relevancy information and advertisement requests and to provide continentally-enhanced relevancy information and bids for continental advertisement placement opportunities associated with the advertisement requests to the advertising brokerage network;
a master IABA to receive the continentally-enhanced relevancy information and advertisement requests and to provide master-enhanced relevancy information and bids for master advertisement placement opportunities associated with the advertisement requests to the advertising brokerage network.

49. The system of claim 48, further comprising:
an ASID monitoring agent to provide performance data to the regional IABA;
a regional IABA monitoring agent to provide the ASID performance data and regional IABA performance data to the continental IABA;
a continental IABA monitoring agent to provide the ASID performance data, the regional IABA performance data, and continental IABA performance data to the master IABA; and
a master IABA performance module to consolidate and report the ASID performance data, the regional IABA performance data, the continental IABA performance data, and master IABA performance data.

50. The system of claim 48, further comprising:
a regional IABA configuration server to configure the ASID and to cross-populate a group subscriber relevancy tag (RT) database associated with the ASID;
a continental IABA configuration server to configure the regional IABA and to cross-populate an RT database associated with the regional IABA; and
a master IABA configuration server to configure the continental IABA and to cross-populating a group subscriber RT database associated with the continental IABA.

51. A method, comprising:
receiving an advertisement request with a user identification;
searching a group subscriber RT database for at least one relevancy tag (RT) associated with the user identification;
matching the at least one RT to a set of RT requirements; and
placing a bid for an advertisement placement opportunity corresponding to the set of RT requirements.

52. The method of claim 51, further comprising:
associating the user identification with the at least one RT in the group subscriber RT database.

53. The method of claim 51, further comprising:
associating an advertisement with the set of RT requirements.

54. The method of claim 51, further comprising:
passing the at least one RT to a content publisher associated with the advertisement request if the bid is successful.

55. A method, comprising:
generating relevancy tags (RTs) at an access stream intercept device (ASID) from relevancy information received at the ASID;
storing the RTs in a subscriber RT database; and
transferring the RTs from the subscriber RT database to an internet advertising brokerage apparatus.

56. The method of claim 55, wherein the relevancy information comprises at least one of a web surfing trend associated with an internet access subscriber, subscriber demographic information, a keyword used in an internet search, data acquired as a result of the internet search, usage data compiled by an internet ratings organization, the existence of a bid to acquire publisher advertisement space, the amount of the bid, content of an advertisement, references to content sources, and indicators related to a relevance of alternate advertisements.

57. The method of claim 55, wherein the relevancy information is received from at least one of a datastream outbound from an internet access computing device (IACD), a datastream inbound to the IACD, a subscriber database associated with an internet service provider (ISP) providing internet access to the IACD, or network equipment associated with an IACD datastream.

58. The method of claim 55, further including:
at a relevancy information agent associated with an internet access computing device (IACD), gathering the relevancy information from at least one of a parameter associated with an operating system executing in the IACD, information passed across an interprocess communication link associated with the IACD, information associated with an application executing at the IACD, or information associated with a remote procedure call (RPC); and
sending the relevancy information from the relevancy information agent to the ASID.

59. The method of claim 55, further including:
accepting a keyword associated with an RT at a relevancy artificial intelligence module;
searching an ontology database using the keyword;
extracting at least one expansion keyword from a record returned from the ontology database; and
synthesizing an expanded RT from the at least one expansion keyword.

60. A method, comprising:
at an internet advertising brokerage apparatus (IABA), accessing an access stream intercept device (ASID) monitoring agent;
reading ASID performance statistics stored by the ASID monitoring agent; and
transferring the ASID performance statistics to an ASID performance statistics database located at the IABA.

61. The method of claim 60, further comprising:
providing the ASID performance statistics to an ASID configuration server on demand.

62. A method, comprising:
at an internet advertising brokerage apparatus (IABA), accessing a set of access stream intercept device (ASID) configuration parameters from an ASID configuration database; and
communicating with an ASID configuration agent to transfer at least one of configuration parameters or database loads to an ASID.

63. The method of claim 62, further comprising:
populating at least one of an ASID publisher inventory database, an ASID subscriber RT database, or an ASID ontology database via the ASID configuration agent.

64. A method, comprising:
at a proxy server, receiving an intercepted communication datastream associated with an internet access computing device (IACD);
extracting first relevancy information from the intercepted communication datastream;
assembling at least one relevancy tag from the first relevancy information and from second relevancy information, the second relevancy information gathered from at least one of a subscriber database associated with an internet service provider (ISP) or network equipment associated with the datastream; and
transmitting the relevancy tag to at least one of an advertiser, an advertisement broker, a publisher, or an internet advertising brokerage apparatus (IABA).

65. The method of claim 64, further comprising:
locating the proxy server at a network node associated with an upstream service provider, the network node positioned upstream from the IACD.

66. The method of claim 65, further comprising:
sending an advertising request from the ISP to the upstream service provider across an out-of-band communication link.

67. The method of claim 65, wherein the upstream service provider comprises a third-party services provider.

68. The method of claim 64, further comprising:
intercepting the communication datastream at an application process executing on at least one of a server, a network interface card (NIC), a proxy server, a service gateway, a traffic shaping appliance, a protocol processing device, a switch, or a router.

69. The method of claim 68, wherein the application process comprises at least one of a service gateway process, a traffic shaping process, or a protocol processing method.

70. The method of claim 64, further comprising:
configuring the proxy server as at least one of a software module, a circuit board, an integrated circuit, or a programmable integrated chip embedded within a packet communication device.

71. A method, comprising:
receiving redirected datastreams associated with a plurality of subscribers at an access stream intercept device (ASID);
appending relevancy information to the redirected datastreams at the ASID;
at a regional internet advertising brokerage apparatus (IABA), receiving the relevancy information and advertisement requests from the ASID;
at the regional IABA, providing regionally-enhanced relevancy information and bids for regional advertisement placement opportunities associated with the advertisement requests to an advertising brokerage network;
at a continental IABA, receiving the regionally-enhanced relevancy information and advertisement requests;
at the continental IABA, providing continentally-enhanced relevancy information and bids for continental advertisement placement opportunities associated with the advertisement requests to the advertising brokerage network;
at a master IABA, receiving the continentally-enhanced relevancy information and advertisement requests; and
at the master IABA, providing master-enhanced relevancy information and bids for master advertisement placement opportunities associated with the advertisement requests to the advertising brokerage network.

72. The method of claim 71, further comprising:
providing ASID performance data to the regional IABA;
at the regional IABA, providing the ASID performance data and regional IABA performance data to the continental IABA;
at the continental IABA, providing the ASID performance data, the regional IABA performance data, and continental IABA performance data to the master IABA; and
at the master IABA, consolidating and reporting the ASID performance data, the regional IABA performance data, the continental IABA performance data, and master IABA performance data.

73. The method of claim 71, further comprising:
at the regional IABA, configuring the ASID and cross-populating a group subscriber relevancy tag (RT) database associated with the ASID;
at the continental IABA, configuring the regional IABA and cross-populating a group subscriber RT database associated with the regional IABA; and
at the master IABA, configuring the continental IABA and cross-populating a group subscriber RT database associated with the continental IABA.

74. A method, comprising:
receiving an advertisement request at a first ad publisher;
redirecting the advertisement request to at least one intermediate ad publisher;
passing the ad request to an internet advertising brokerage apparatus (IABA); and
delivering a pre-populated advertisement from the IABA to a requesting subscriber without traversing at least one intermediate publisher.

75. The method of claim 74, further comprising:
redirecting the advertising request to an advertiser.

76. The method of claim 75, further comprising:
communicating the advertising request to the IABA from at least one of the advertiser or an access stream intercept device (ASID) associated with a requesting internet access computing device (IACD).

77. A method of communicating relevancy information from an ASID to an internet advertising brokerage apparatus (IABA), comprising at least one of:
appending a relevancy tag (RT) to an HTTP request;
redirecting an advertising request including the RT from the ASID to the IABA; or
sending an internet protocol (IP) address from the ASID to the IABA to index the RT from an RT database at the IABA.

78. A method of identifying a particular IACD among a plurality of IACDs behind a firewall at an access stream intercept device (ASID), comprising at least one of:
mapping a transport control protocol (TCP) port number to the particular IACD;
mapping an authentication identifier produced by an ISP authentication process to the particular IACD;
mapping a user agent identifier to the particular IACD; or
mapping a language identifier to the particular IACD.

79. A method, comprising:
at an internet advertising brokerage apparatus (IABA), populating a hierarchical ontology database with records, each record to include a keyword field, an associated category keyword field, and a uniform resource locator (URL) field.

80. The method of claim 79, further comprising:
accessing a world-wide web page at a URL associated with the URL field to obtain associated category keywords to populate into the associated category keyword field.

81. A method of synthesizing additional keyword relevancy tags (RTs), including:
accepting a keyword RT to be expanded from a requesting process;
searching an ontology database for the keyword RT to be expanded;
extracting the additional keyword RTs from uniform resource locator (URL) records returned by a search of the ontology database; and
returning the additional keyword RTs to the requesting process.
